(19) United States
(12) Patent Application Publication
(10) Pub. No.: US 2025/0037032 A1
(43) Pub. Date: Jan. 30, 2025

(54) APPARATUS AND METHODS FOR MULTI-STAGE MACHINE LEARNING WITH CASCADED MODELS

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA)

(21) Appl. No.: 18/914,908

(22) Filed: Oct. 14, 2024

Related U.S. Application Data
(63) Continuation of application No. PCT/CN2022/087089, filed on Apr. 15, 2022.

(51) Int. Cl. G06N 20/00

(52) U.S. Cl. CPC G06N 20/00

(57) ABSTRACT

Data heterogeneity has been shown to reduce the convergence speed and model accuracy in existing federated learning (FL) and distributed learning (DL) based artificial intelligence or machine learning (AI/ML) model training processes. In some embodiments, a group of devices participating in an FL or DL based AI/ML model training process is divided into clusters, e.g., based on similarities in their data class distributions, and each device is configured with a cascaded AI/ML model that includes a first AI/ML sub-model and a second AI/ML sub-model that are cascaded. For each device, one of the cascaded sub-models is a common AI/ML sub-model that is common to all devices in the group, and the other sub-model is a cluster-specific AI/ML sub-model that is common to the cluster that the device has been assigned to within the group of devices. A multi-stage training process for the cascaded AI/ML model is also provided.

### CROSS-REFERENCE TO RELATED APPLICATIONS

This application is a continuation of International Application No. PCT/CN2022/087089, filed on Apr. 15, 2022, which is hereby incorporated by reference in its entirety.

### TECHNICAL FIELD

The present disclosure relates to wireless communication generally, and, in particular embodiments, to methods and apparatuses for multi-stage machine learning with cascaded models.

### BACKGROUND

Artificial Intelligence (AI) technologies may be applied in communication, including AI-based communication in the physical layer and/or AI-based communication in the medium access control (MAC) layer. For example, in the physical layer, the AI-based communication may aim to optimize component design and/or improve the algorithm performance. For the MAC layer, the AI-based communication may aim to utilize the AI capability for learning, prediction, and/or making a decision to solve a complicated optimization problem with possible better strategy and/or optimal solution, e.g. to optimize the functionality in the MAC layer.

Conventional AI training processes generally rely on hybrid automatic repeat request (HARQ) feedback and retransmission processes to try to ensure that data communicated between devices involved in AI training is successfully received. However, the communication overhead and delay associated with such retransmissions can be problematic.

### SUMMARY

According to a first broad aspect of the present disclosure, there is provided herein a method for configuring artificial intelligence or machine learning (AI/ML) in a wireless communication network. The method according to the first broad aspect of the present disclosure may include receiving, by a first device in a wireless communication network, first AI/ML sub-model configuration information from a network device for configuring a first AI/ML sub-model, and receiving, by the first device, a second AI/ML sub-model configuration information from the network device for configuring a second AI/ML sub-model. The first AI/ML sub-model configuration information may be received using a first radio network temporary identifier (RNTI) and the second AI/ML sub-model configuration information may be received using a second RNTI different from the first RNTI. The method according to the first broad aspect of the present disclosure may further include configuring, by the first device, an AI/ML model on the first device such that the AI/ML model includes the first AI/ML sub-model and the second AI/ML sub-model, the first AI/ML sub-model and the second AI/ML sub-model being cascaded such that an output of the first AI/ML sub-model is an input of the second AI/ML sub-model.

Configuring cascaded AI/ML models in accordance with the first broad aspect of the present disclosure can have several advantages. For example, when used in cluster-based federated or distributed learning schemes, configuring cascaded AI/ML models in accordance with the first broad aspect of the present disclosure can potentially solve the data heterogeneity problem that can occur in existing non-cluster based training schemes while also resolving or at least substantially mitigating one or more of the problems commonly associated with existing cluster-based learning schemes, such as reduced convergence speed and high downlink communication overhead, as discussed in further detail herein.

In some embodiments, an input of the first AI/ML sub-model is an input of the AI/ML model and an output of the second AI/ML sub-model is an output of the AI/ML model.

In some embodiments, one of the first AI/ML sub-model and the second AI/ML sub-model is an AI/ML sub-model 1 that is common to a group of devices in the wireless communication network, and the other one of the first AI/ML sub-model and the second AI/ML sub-model is an AI/ML sub-model 2 that is common to a first cluster of one or more devices, inclusive of the first device, within the group of devices.

In some embodiments, the first RNTI is common to the group of devices and the first AI/ML sub-model is the AI/ML sub-model 1, and the second RNTI is common to the first cluster of one or more devices and the second AI/ML sub-model is the AI/ML sub-model 2.

In some embodiments, the method according to the first broad aspect of the present disclosure further includes receiving signaling from the network device configuring the first device to train the AI/ML model on the first device in accordance with a training stage selected from a plurality of training modes of a multi-stage AI/ML model training process, the plurality of training modes of the multi-stage AI/ML model training process including a first training stage in which parameters of the AI/ML sub-model 1 are trained and parameters of the AI/ML sub-model 2 are fixed. In such embodiments, the method may further include transmitting local AI/ML model update information to the network device, the local AI/ML model update information being based on training of the AI/ML model on the first device in accordance with the selected training stage.

In some embodiments, the signaling configuring the first device to train the AI/ML model on the first device in accordance with the selected training stage causes the first device to switch to the selected training stage from a different training stage of the plurality of training modes.

In some embodiments, the signaling configuring the first device to train the AI/ML model on the first device in accordance with the selected training stage configures the first device to train the AI/ML model on the first device in accordance with the first training stage in which parameters of the AI/ML sub-model 1 are trained and parameters of the AI/ML sub-model 2 are fixed.

In some embodiments, the method according to the first broad aspect of the present disclosure further includes, in the first training stage, for an iteration of the multi-stage AI/ML model training process, receiving, from the network device, global common AI/ML sub-model update information including global common AI/ML sub-model parameter updates for a global common AI/ML sub-model. In some such embodiments, the method may further include transmitting local AI/ML model update information to the network device, the local AI/ML model update information including local common AI/ML sub-model parameter updates for the AI/ML sub-model 1 on the first device based on the global common AI/ML sub-model parameter updates received from the network device.

In some embodiments, transmission, from the network device, of the global common AI/ML sub-model update information is scheduled by first downlink control information (DCI), wherein a cyclic redundancy check (CRC) value of the first DCI is scrambled with the first RNTI, the first RNTI being a common RNTI that is common to the group of devices in the wireless communication network. In such embodiments, receiving the global common AI/ML sub-model update information from the network device may include descrambling the CRC value of the first DCI with the first RNTI to determine the scheduling of the transmission of the global common AI/ML sub-model update information from the network device.

In some embodiments, the method according to the first broad aspect of the present disclosure further includes transmitting, from the first device, AI/ML model correlation information to the network device, the AI/ML model correlation information including information regarding a correlation between the AI/ML sub-model 1 on the first device and the global common AI/ML sub-model.

In some embodiments, the information regarding a correlation between the AI/ML sub-model 1 on the first device and the global common AI/ML sub-model is determined by the first device based on: local common AI/ML sub-model update information including local common AI/ML sub-model parameter updates based on training of the AI/ML sub-model 1 on the first device; and the global common AI/ML sub-model update information received from the network device.

In some embodiments, the signaling configuring the first device to train the AI/ML model on the first device in accordance with the selected training stage configures the first device to train the AI/ML model on the first device in accordance with a second training stage of the plurality of training modes, wherein in the second training stage parameters of the AI/ML sub-model 2 are trained.

In some embodiments, the control signaling configuring the first device to train the AI/ML model on the first device in accordance with the second training stage causes the first device to switch from the first training stage to the second training stage of the plurality of training modes.

In some embodiments, the method according to the first broad aspect of the present disclosure further includes, in the second training stage, for an iteration of the multi-stage AI/ML model training process, receiving, from the network device, global cluster-specific AI/ML sub-model update information including global cluster-specific AI/ML sub-model parameter updates for a global cluster-specific AI/ML sub-model. In some such embodiments, the method may further include transmitting local AI/ML model update information to the network device, the local AI/ML model update information including local cluster-specific AI/ML sub-model parameter updates for the AI/ML sub-model 2 on the first device based on the global cluster-specific AI/ML sub-model parameter updates received from the network device.

In some embodiments, transmission, from the network device, of the global cluster-specific AI/ML sub-model update information is scheduled by second DCI, wherein a CRC value of the second DCI is scrambled with the second RNTI, the second RNTI being a cluster-specific RNTI that is common to the first cluster of devices. In such embodiments, receiving the global cluster-specific AI/ML sub-model update information from the network device may include descrambling the CRC value of the second DCI with the second RNTI to determine the scheduling of the transmission of the global cluster-specific AI/ML sub-model update information from the network device.

In some embodiments, the method according to the first broad aspect of the present disclosure further includes, for the iteration in the second training stage, receiving, from the network device, global common AI/ML sub-model update information including global common AI/ML sub-model parameter updates for a global common AI/ML sub-model. In such embodiments, the local AI/ML model update information transmitted to the network device may further include local common AI/ML sub-model parameter updates for the AI/ML sub-model 1 on the first device based on the global common AI/ML sub-model parameter updates received from the network device.

In some embodiments, transmission, from the network device, of the global common AI/ML sub-model update information is scheduled by first DCI, wherein a CRC value of the first DCI is scrambled with the first RNTI, the first RNTI being a common RNTI that is common to the group of devices in the wireless communication network. In such embodiments, receiving the global common AI/ML sub-model update information from the network device may include descrambling the CRC value of the first DCI with the first RNTI to determine the scheduling of the transmission of the global common AI/ML sub-model update information from the network device.

In some embodiments, the method according to the first broad aspect of the present disclosure further includes transmitting, from the first device, AI/ML model correlation information to the network device, the AI/ML model correlation information including information regarding a correlation between the AI/ML sub-model 1 on the first device and the global common AI/ML sub-model.

In some embodiments, the information regarding a correlation between the AI/ML sub-model 1 on the first device and the global common AI/ML sub-model is determined by the first device based on: local common AI/ML sub-model update information including local common AI/ML sub-model parameter updates based on training of the AI/ML sub-model 1 on the first device; and the global common AI/ML sub-model update information received from the network device.

In some embodiments, the method according to the first broad aspect of the present disclosure further includes receiving, from the network device, second AI/ML model configuration information for configuring the AI/ML model such that the AI/ML model on the first device includes a second AI/ML model, wherein an input of the second AI/ML model is an input of the AI/ML model and an output of the second AI/ML model is an output of the AI/ML model, the second AI/ML model configuration information including AI/ML model parameters for the second AI/ML model. In some such embodiments, the method may further include configuring the AI/ML model on the first device based on the second AI/ML model configuration information received from the network device.

In some embodiments, the method according to the first broad aspect of the present disclosure further includes receiving signaling from the network device configuring the first device to train the AI/ML model on the first device in accordance with a third training stage of the plurality of training modes, wherein, in the third training stage, parameters of the second AI/ML model are trained.

In some embodiments, the signaling configuring the first device to train the AI/ML model on the first device in accordance with the third training stage causes the first device to switch from the second training stage to the third training stage.

In some embodiments, the method according to the first broad aspect of the present disclosure further includes, in the third training stage, for an iteration of the multi-stage AI/ML model training process, receiving, from the network device, global common AI/ML model update information including global common AI/ML model parameter updates for a global common AI/ML model. In some such embodiments, the method may further include transmitting local AI/ML model update information to the network device, the local AI/ML model update information including local common AI/ML model parameter updates for the second AI/ML model on the first device based on the global common AI/ML model parameter updates received from the network device.

In some embodiments, transmission, from the network device, of the global common AI/ML model update information is scheduled by first DCI, wherein a CRC value of the first DCI is scrambled with a third RNTI, the third RNTI being a common RNTI that is common to the group of devices in the wireless communication network, wherein the third RNTI is different from at least one of the first RNTI and the second RNTI. In such embodiments, receiving the global common AI/ML model update information from the network device may include descrambling the CRC value of the first DCI with the third RNTI to determine the scheduling of the transmission of the global common AI/ML model update information from the network device.

In some embodiments, the method according to the first broad aspect of the present disclosure further includes receiving, from the network device, global cluster-specific AI/ML sub-model update information including global cluster-specific AI/ML sub-model parameter updates for a global cluster-specific AI/ML sub-model. In such embodiments, the method may further include updating the configuration of the AI/ML sub-model 2 on the first device based on the global cluster-specific AI/ML sub-model parameter updates received from the network device.

In some embodiments, receiving the global cluster-specific AI/ML sub-model update information includes receiving, by the first device, a first stage DCI scrambled with one of the first RNTI and the second RNTI in a physical downlink control channel (PDCCH), the one of the first RNTI and the second RNTI being a common RNTI that is common to the group of devices in the wireless communication network, the first stage DCI indicating a scheduling information of a second stage DCI. The first device may then receive the second stage DCI in a first physical downlink shared channel (PDSCH) using PDSCH resources indicated by the scheduling information in the first stage DCI, wherein the first PDSCH is a physical channel without data transmission, the second stage DCI indicating a scheduling information of at least one downlink data transmission. The first device may then receive a downlink data transmission scrambled by the other one of the first RNTI and the second RNTI in a second PDSCH using PDSCH resources indicated by the scheduling information in the second stage DCI, the other one of the first RNTI and the second RNTI being a cluster-specific RNTI that is common to the first cluster of devices, the downlink data transmission including the global cluster-specific AI/ML sub-model update information for the first cluster of devices.

In some embodiments, the scheduling information in the second DCI includes a field indicating which cluster(s) of devices have a downlink data transmission scheduled by the second DCI.

In some embodiments, the method according to the first broad aspect of the present disclosure further includes receiving, by the first device, signaling from the network device indicating that the first cluster of devices and a second cluster of devices in the group of devices are to be merged into a third cluster of devices.

In some embodiments, receiving the signaling indicating that the first cluster and the second cluster are to be merged into the third cluster includes receiving, by the first device, a first stage DCI scrambled with one of the first RNTI and the second RNTI in a physical downlink control channel (PDCCH), the one of the first RNTI and the second RNTI being a common RNTI that is common to the group of devices in the wireless communication network, the first stage DCI indicating a scheduling information of a second stage DCI. The first device may then receive the second stage DCI in a first physical downlink shared channel (PDSCH) using PDSCH resources indicated by the scheduling information in the first stage DCI, wherein the first PDSCH is a physical channel without data transmission, the second stage DCI including a cluster merging field indicating, for each set of merged clusters, a cluster-specific RNTI to be used by devices in the merged cluster, wherein for the merging of the first cluster and the second cluster into the third cluster, the cluster merging field in the second DCI indicates a third RNTI, the third RNTI being a cluster-specific RNTI common to devices in the third cluster.

In some embodiments, the second stage DCI further indicates a scheduling information of at least one downlink data transmission. In such embodiments, the method according to the first broad aspect of the present invention may further include receiving, by the first device, a downlink data transmission scrambled by the third RNTI in a third PDSCH using PDSCH resources indicated by the scheduling information in the second stage DCI, the downlink data transmission scrambled by the third RNTI including global cluster-specific AI/ML sub-model update information for the third cluster of devices. In some embodiments, the configuration of the AI/ML sub-model 2 on the first device may then be updated based on global cluster-specific AI/ML sub-model parameter updates indicated in the global cluster-specific AI/ML sub-model update information for the third cluster of devices.

In some embodiments, the method according to the first broad aspect of the present disclosure further includes receiving, by the first device, signaling from the network device indicating that the first device is to be switched into a second cluster of devices in the group of devices.

In some embodiments, receiving the signaling indicating that the first device is to be switched into the second cluster of devices includes receiving, by the first device, a first stage DCI scrambled with one of the first RNTI and the second RNTI in a physical downlink control channel (PDCCH), the one of the first RNTI and the second RNTI being a common RNTI that is common to the group of devices in the wireless communication network, the first stage DCI indicating a scheduling information of a second stage DCI. The first device may then receive the second stage DCI in a first physical downlink shared channel (PDSCH) using PDSCH resources indicated by the scheduling information in the first stage DCI, wherein the first PDSCH is a physical channel without data transmission, the second stage DCI including a cluster switching field indicating, for each device that is switching clusters, a cluster-specific RNTI to be used by the device in the cluster into which the device is being switched, wherein for switching the first device into the second cluster, the cluster switching field in the second DCI indicates a third RNTI to be used by the first device, the third RNTI being a cluster-specific RNTI common to devices in the second cluster.

According to a second broad aspect of the present disclosure, there is provided herein another method for configuring AI/ML in a wireless communication network. The method according to the second broad aspect of the present disclosure may include configuring, by a network device in a wireless communication network, a first global AI/ML model such that the first global AI/ML model includes a first global AI/ML sub-model and a second global AI/ML sub-model, the first global AI/ML sub-model and the second global AI/ML sub-model being cascaded such that an output of the first global AI/ML sub-model is an input of the second global AI/ML sub-model. For example, one of the first global AI/ML sub-model and the second global AI/ML sub-model may be a global common AI/ML sub-model that is common to a group of devices in the wireless communication network, and the other one of the first global AI/ML sub-model and the second global AI/ML sub-model may be a first global cluster-specific AI/ML sub-model that is common to a first cluster of one or more devices within the group of devices.

Configuring cascaded AI/ML models in accordance with the second broad aspect of the present disclosure can have several advantages. For example, configuring a cascaded AI/ML model in accordance with the first broad aspect of the present disclosure can potentially solve the data heterogeneity problem that can occur in existing non-cluster based training schemes while also resolving or at least substantially mitigating one or more of the problems commonly associated with existing cluster-based learning schemes, such as reduced convergence speed and high downlink communication overhead, as discussed in further detail herein.

In some embodiments, an input of the first global AI/ML sub-model is an input of the first global AI/ML model and an output of the second global AI/ML sub-model is an output of the first global AI/ML model.

In some embodiments, the first global AI/ML sub-model is the global common AI/ML sub-model and the second global AI/ML sub-model is the first global cluster-specific sub-model.

In some embodiments, the method according to the second broad aspect of the present disclosure further includes transmitting, by the network device, first AI/ML model configuration information for configuring, on a first device in the wireless communication network, an AI/ML model corresponding to the first global AI/ML model such that the AI/ML model on the first device includes a first AI/ML sub-model corresponding to the first global AI/ML sub-model and a second AI/ML sub-model corresponding to the second global AI/ML sub-model, the first AI/ML sub-model and the second AI/ML sub-model being cascaded such that an output of the first AI/ML sub-model is an input of the second AI/ML sub-model, the first AI/ML model configuration information including AI/ML model parameters for the first AI/ML sub-model and the second AI/ML sub-model.

In some embodiments, transmitting first AI/ML model configuration information for configuring the first AI/ML model on the first device includes transmitting, by the network device, first AI/ML sub-model configuration information for configuring the first AI/ML sub-model, the first AI/ML sub-model configuration information being transmitted using a first radio network temporary identifier (RNTI). In some such embodiments, transmitting the first AI/ML model configuration information may further include transmitting, by the network device, second AI/ML sub-model configuration information for configuring the second AI/ML sub-model, the second AI/ML sub-model configuration information being transmitted using a second RNTI different from the first RNTI.

In some embodiments, the method according to the second broad aspect of the present disclosure further includes transmitting, by the network device, signaling to configure the first device to train the AI/ML model on the first device in accordance with a training stage selected from a plurality of training modes of a multi-stage AI/ML model training process, the plurality of training modes of the multi-stage AI/ML model training process including a first training stage in which parameters of the global common AI/ML sub-model are trained and parameters of the first global cluster-specific AI/ML sub-model are fixed. In some such embodiments, the method may further include receiving, by the network device, local AI/ML model update information from the first device, the local AI/ML model update information being based on training of the AI/ML model on the first device in accordance with the selected training stage.

In some embodiments, the signaling configuring the first device to train the AI/ML model on the first device in accordance with the selected training stage causes the first device to switch to the selected training stage from a different training stage of the plurality of training modes.

In some embodiments, the signaling configuring the first device to train the AI/ML model on the first device in accordance with the selected training stage configures the first device to train the AI/ML model on the first device in accordance with the first training stage in which parameters of the global common AI/ML sub-model are trained and parameters of the first global cluster-specific AI/ML sub-model are fixed.

In some embodiments, the method according to the second broad aspect of the present disclosure further includes, in the first training stage, for an iteration of the multi-stage AI/ML model training process, receiving, by the network device, local AI/ML model update information from the first device, the local AI/ML model update information including local common AI/ML sub-model parameter updates for the AI/ML sub-model on the first device that corresponds to the global common AI/ML sub-model. In some such embodiments, the method may further include transmitting, by the network device, global common AI/ML sub-model update information including global common AI/ML sub-model parameter updates for the global common AI/ML sub-model based on the local common AI/ML sub-model parameter updates received from the first device.

In some embodiments, transmission, from the network device, of the global common AI/ML sub-model update information is scheduled by transmitting first downlink control information (DCI), wherein a cyclic redundancy check (CRC) value of the first DCI is scrambled with a first radio network temporary identifier (RNTI), the first RNTI being a common RNTI that is common to the group of devices in the wireless communication network.

In some embodiments, the method according to the second broad aspect of the present disclosure further includes receiving, by the network device, AI/ML model correlation information from the first device, the AI/ML model correlation information from the first device including information regarding a correlation between the global common AI/ML sub-model and the corresponding AI/ML sub-model on the first device.

In some embodiments, the method according to the second broad aspect of the present disclosure further includes the signaling configuring the first device to train the AI/ML model on the first device in accordance with the selected training stage configures the first device to train the AI/ML model on the first device in accordance with a second training stage of the plurality of training modes, wherein in the second training stage parameters of the first global cluster-specific AI/ML sub-model are trained.

In some embodiments, the signaling configuring the first device to train the AI/ML model on the first device in accordance with the second training stage causes the first device to switch from the first training stage to the second training stage of the plurality of training modes.

In some embodiments, the method according to the second broad aspect of the present disclosure further includes, in the second training stage, for an iteration of the multi-stage AI/ML model training process, receiving, by the network device, local AI/ML model update information from the first device, the local AI/ML model update information including local cluster-specific AI/ML sub-model parameter updates for the AI/ML sub-model on the first device that corresponds to the first global cluster-specific AI/ML sub-model. In some such embodiments, the method may further include transmitting, by the network device, global cluster-specific AI/ML sub-model update information including global cluster-specific AI/ML sub-model parameter updates for the first global cluster-specific AI/ML sub-model based on the local cluster-specific AI/ML sub-model parameter updates received from the first device.

In some embodiments, transmission, from the network device, of the global cluster-specific AI/ML sub-model update information is scheduled by transmitting second DCI, wherein a CRC value of the second DCI is scrambled with a second RNTI, the second RNTI being a cluster-specific RNTI that is common to the first cluster of devices.

In some embodiments, the local AI/ML model update information received from the first device further includes local common AI/ML sub-model parameter updates for the AI/ML sub-model on the first device that corresponds to the global common AI/ML sub-model. In such embodiments, the method according to the second broad aspect of the present disclosure may further include, for the iteration in the second training stage, transmitting, by the network device, global common AI/ML sub-model update information including global common AI/ML sub-model parameter updates for the global common AI/ML sub-model based on the local common AI/ML sub-model parameter updates received from the first device.

In some embodiments, transmission, from the network device, of the global common AI/ML sub-model update information is scheduled by transmitting first DCI, wherein a CRC value of the first DCI is scrambled with a first RNTI, the first RNTI being a common RNTI that is common to the group of devices in the wireless communication network.

In some embodiments, the method according to the second broad aspect of the present disclosure further includes receiving, by the network device, AI/ML model correlation information from the first device, the AI/ML model correlation information including information regarding a correlation between the global common AI/ML sub-model and the corresponding AI/ML sub-model on the first device.

In some embodiments, the method according to the second broad aspect of the present disclosure further includes configuring, by the network device, a second global AI/ML model based on the first global AI/ML model such that the second global AI/ML model includes a global common AI/ML model that is common to the group of devices, wherein an input of the global common AI/ML model is an input of the second global AI/ML model and an output of the global common AI/ML model is an output of the second global AI/ML model. In some such embodiments, the method may further include transmitting, by the network device, second AI/ML model configuration information for configuring the AI/ML model on the first device such that the AI/ML model on the first device includes a second AI/ML model corresponding to the global common AI/ML model, wherein an input of the second AI/ML model is an input of the AI/ML model on the first device and an output of the second AI/ML model is an output of the AI/ML model on the first device, the second AI/ML model configuration information including AI/ML model parameters for the second AI/ML model.

In some embodiments, the method according to the second broad aspect of the present disclosure further includes transmitting, by the network device, signaling configuring the first device to train the AI/ML model on the first device in accordance with a third training stage of the plurality of training modes, wherein, in the third training stage, parameters of the second AI/ML model are trained.

In some embodiments, the signaling configuring the first device to train the AI/ML model on the first device in accordance with the third training stage causes the first device to switch from the second training stage to the third training stage.

In some embodiments, the method according to the second broad aspect of the present disclosure further includes, in the third training stage, for an iteration of the multi-stage AI/ML model training process, receiving, by the network device, local AI/ML model update information from the first device, the local AI/ML model update information including local common AI/ML model parameter updates for the second AI/ML model on the first device. In some such embodiments, the method may further include transmitting, by the network device, global common AI/ML model update information including global common AI/ML model parameter updates for the global common AI/ML model based on the local common AI/ML model parameter updates received from the first device.

In some embodiments, transmission, from the network device, of the global common AI/ML model update information is scheduled by transmitting first DCI, wherein a CRC value of the first DCI is scrambled with a first RNTI, the first RNTI being a common RNTI that is common to the group of devices in the wireless communication network.

In some embodiments, the method according to the second broad aspect of the present disclosure further includes transmitting, by the network device, global cluster-specific AI/ML sub-model update information including global cluster-specific AI/ML sub-model parameter updates for the global cluster-specific AI/ML sub-model for the first cluster of devices.

In some embodiments, transmitting the global cluster-specific AI/ML sub-model update information includes transmitting, by the network device, a first stage DCI scrambled with a first radio network temporary identifier (RNTI) in a physical downlink control channel (PDCCH), the first RNTI being a common RNTI that is common to the group of devices in the wireless communication network, the first stage DCI indicating a scheduling information of a second stage DCI. For example, the second stage DCI may be transmitted by the network device in a first physical downlink shared channel (PDSCH) using PDSCH resources indicated by the scheduling information in the first stage DCI, wherein the first PDSCH is a physical channel without data transmission, the second stage DCI indicating a scheduling information of at least one downlink data transmission. The network device may transmit a downlink data transmission scrambled by a second RNTI in a second PDSCH using PDSCH resources indicated by the scheduling information in the second stage DCI, the second RNTI being a cluster-specific RNTI that is common to the first cluster of devices, the downlink data transmission including the global cluster-specific AI/ML sub-model update information for the first cluster of devices.

In some embodiments, the scheduling information in the second DCI includes a field indicating which cluster(s) of devices have a downlink data transmission scheduled by the second DCI.

In some embodiments, the method according to the second broad aspect of the present disclosure further includes transmitting, by the network device, signaling indicating that the first cluster of devices and a second cluster of devices in the group of devices are to be merged into a third cluster of devices.

In some embodiments, transmitting the signaling indicating that the first cluster and the second cluster are to be merged into the third cluster includes transmitting, by the network device, a first stage DCI scrambled with a first radio network temporary identifier (RNTI) in a physical downlink control channel (PDCCH), the first RNTI being a common RNTI that is common to the group of devices in the wireless communication network, the first stage DCI indicating a scheduling information of a second stage DCI. For example, the network device may transmit the second stage DCI in a first physical downlink shared channel (PDSCH) using PDSCH resources indicated by the scheduling information in the first stage DCI, wherein the first PDSCH is a physical channel without data transmission, the second stage DCI including a cluster merging field indicating, for each set of merged clusters, a cluster-specific RNTI to be used by devices in the merged cluster, wherein for the merging of the first cluster and the second cluster into the third cluster, the cluster merging field in the second DCI indicates a third RNTI, the third RNTI being a cluster-specific RNTI common to devices in the third cluster.

In some embodiments, the second stage DCI further indicates a scheduling information of at least one downlink data transmission. In such embodiments, the method according to the second broad aspect of the present invention may further include transmitting, by the network device, a downlink data transmission scrambled by the third RNTI in a third PDSCH using PDSCH resources indicated by the scheduling information in the second stage DCI, the downlink data transmission scrambled by the third RNTI including global cluster-specific AI/ML sub-model update information for the third cluster of devices.

In some embodiments, the method according to the second broad aspect of the present disclosure further includes transmitting, by the network device, signaling indicating that the first device is to be switched into a second cluster of devices in the group of devices.

In some embodiments, transmitting the signaling indicating that the first device is to be switched into the second cluster of devices includes transmitting, by the network device, a first stage DCI scrambled with a first radio network temporary identifier (RNTI) in a physical downlink control channel (PDCCH), the first RNTI being a common RNTI that is common to the group of devices in the wireless communication network, the first stage DCI indicating a scheduling information of a second stage DCI. For example, the network device may transmit the second stage DCI in a first physical downlink shared channel (PDSCH) using PDSCH resources indicated by the scheduling information in the first stage DCI, wherein the first PDSCH is a physical channel without data transmission, the second stage DCI including a cluster switching field indicating, for each device that is switching clusters, a cluster-specific RNTI to be used by the device in the cluster into which the device is being switched, wherein for switching the first device into the second cluster, the cluster switching field in the second DCI indicates a third RNTI to be used by the first device, the third RNTI being a cluster-specific RNTI common to devices in the second cluster.

Corresponding apparatuses and devices are disclosed for performing the methods.

For example, according to another aspect of the disclosure, a device is provided that includes a processor and a memory storing processor-executable instructions that, when executed, cause the processor to carry out a method according to the first broad aspect of the present disclosure described above.

As another example, according to another aspect of the disclosure, a network device is provided that includes a processor and a memory storing processor-executable instructions that, when executed, cause the processor to carry out a method according to the second broad aspect of the present disclosure described above.

According to other aspects of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates four EDs communicating with a network device in a communication system, according to one embodiment;

FIG. 6A illustrates and example of a neural network with multiple layers of neurons, according to one embodiment;

FIG. 6B illustrates an example of a neuron that may be used as a building block for a neural network, according to one embodiment;

FIG. 7A illustrates an example of a communication system in which a cluster-based federated learning process for AI/ML model training is being used, wherein devices are clustered based on their training data class distributions and a cluster-specific AI/ML model is trained for each cluster;

FIG. 7B shows an example of a problem that can occur in the communication system of FIG. 7A if changing radio environment conditions cause a device's inferring data class distribution to differ from the device's training data class distribution.

FIG. 8A illustrates an example of an AI/ML model that includes two cascaded sub-models according to one embodiment;

FIG. 8B illustrates an example implementation of the two cascaded sub-models of FIG. 8A according to one embodiment;

FIG. 9A illustrates another example of an AI/ML model that includes two cascaded sub-models according to one embodiment;

FIG. 9B illustrates an example implementation of the two cascaded sub-models of FIG. 9A according to one embodiment;

FIG. 10 illustrates an example of the two cascaded sub-models of FIG. 8A during the first stage of a multi-stage AI/ML model training process according to one embodiment;

FIG. 11 illustrates an example signal flow diagram between a network device and a user equipment for one iteration of a first stage of a multi-stage AI/ML model training process according to one embodiment;

FIG. 12 illustrates an example of the two cascaded sub-models of FIG. 8A during the second stage of a multi-stage AI/ML model training process according to one embodiment;

FIG. 13 illustrates an example signal flow diagram between a network device and a user equipment for one iteration of a second stage of a multi-stage AI/ML model training process according to one embodiment;

FIG. 14 illustrates an example of a merged global AI/ML model during a third stage of a multi-stage AI/ML model training process according to one embodiment;

FIG. 15 illustrates an example signal flow diagram between a network device and a user equipment for one iteration of a third stage of a multi-stage AI/ML model training process according to one embodiment;

FIG. 16 illustrates an example of a flowchart for a multi-stage federated learning-based AI/ML model training process according to one embodiment;

FIG. 17A shows time frequency resources for a two-stage downlink control information (DCI);

FIG. 17B shows time division multiplexing and frequency division multiplexing for a two-stage DCI;

FIG. 18 shows a protocol stack showing an example of how a two-stage DCI is transmitted;

FIG. 19 shows an example of a two-stage DCI in which the second DCI indicates scheduling information for cluster-specific downlink transmissions according to one embodiment;

FIG. 20 shows an example of a two-stage DCI in which the second DCI indicates cluster merging information according to one embodiment; and

FIG. 21 shows an example of a two-stage DCI in which the second DCI indicates cluster switching information according to one embodiment.

Similar reference numerals may have been used in different figures to denote similar components.

### DETAILED DESCRIPTION OF ILLUSTRATIVE EMBODIMENTS

For illustrative purposes, specific example embodiments will now be explained in greater detail below in conjunction with the figures.

### Example Communication Systems and Devices

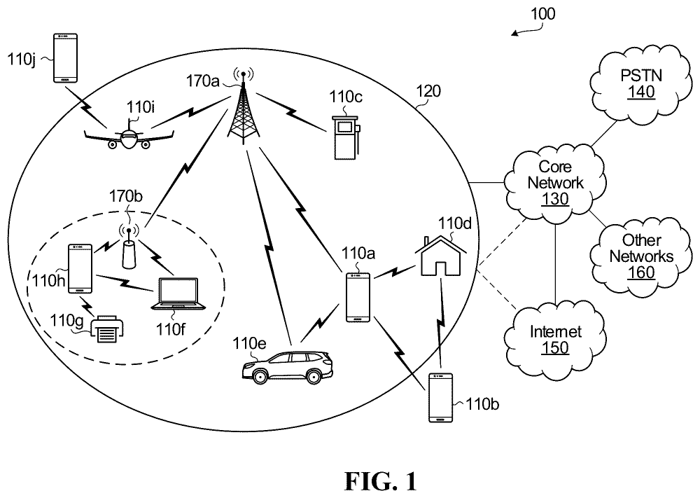

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

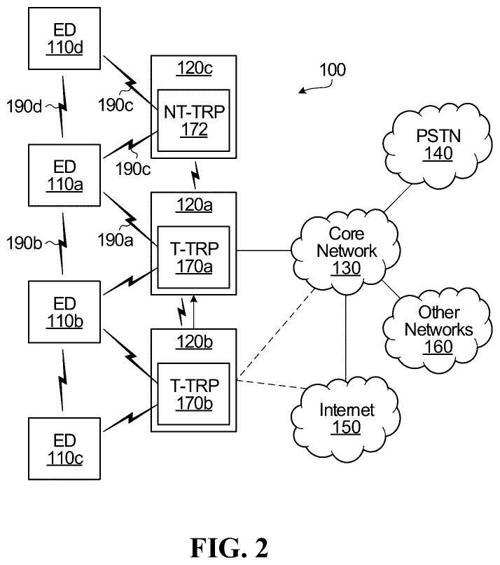

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

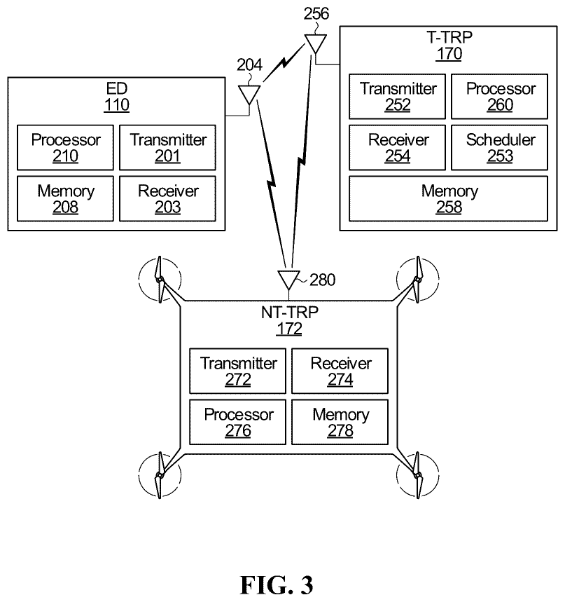

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs no may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

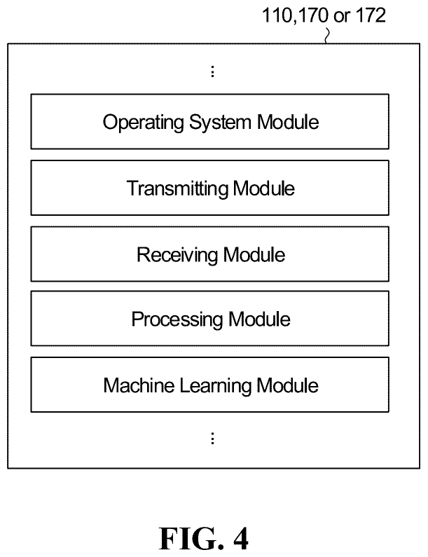

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage □/2 of the total mean transmitted power, for example, the value of □/2 is taken as 0-5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

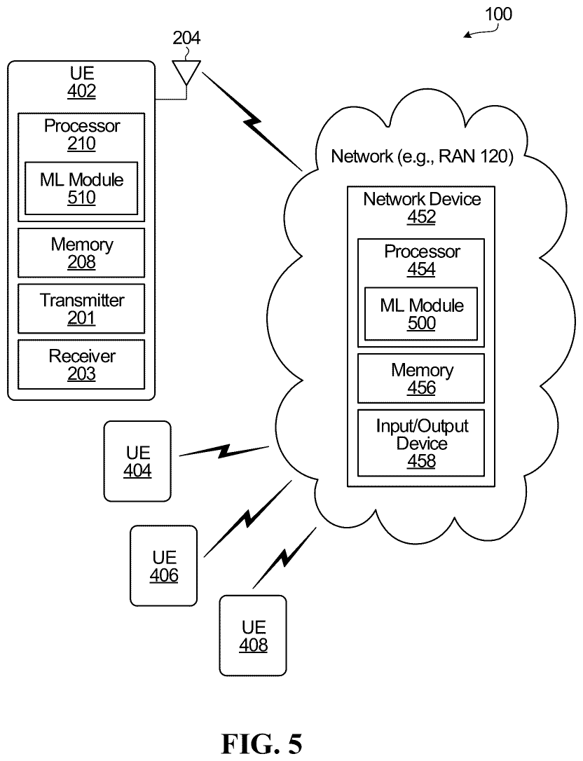

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 352 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402,404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

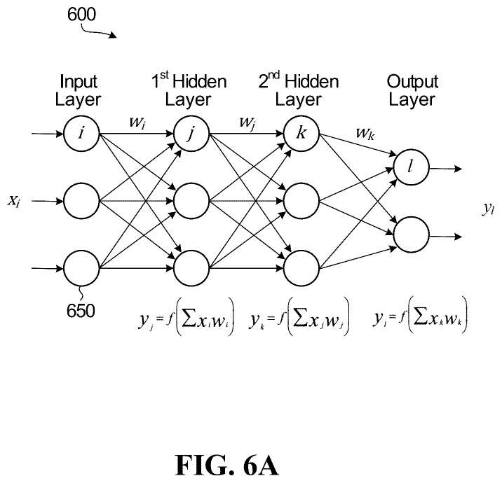

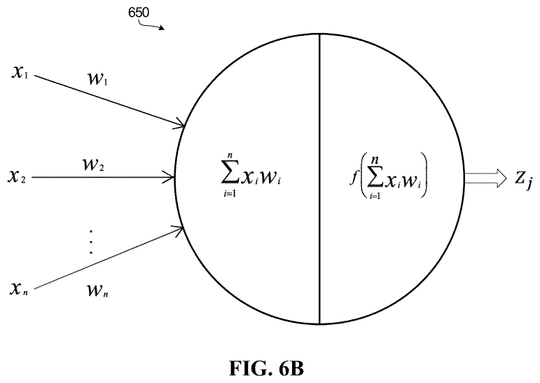

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function ƒ( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

Referring again to FIG. 5, for wireless federated learning (FL), the network device 452 may initialize a global AI/ML model implemented by the ML module 500, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of federated learning-based (FL-based) AI/ML model training procedure. The network device 452 and the UEs 402, 404, 406 and 408 perform multiple iterations until the AI/ML model has converged sufficiently to satisfy one or more training goals/criteria and the AI/ML model is finalized.

However, one significant problem that can arise in conventional FL-based training processes is data heterogeneity. In FL-based training processes, each device participating in the FL-based training process trains its local AI/ML model using its own local training dataset, while maintaining local data decentralization (i.e., a UE's local training dataset is kept at the UE and is not shared as part of the training process). This has advantages from a privacy perspective, because each UE's local training dataset is kept private. However, different UEs may observe different training datasets that may not be representative of the distribution of all the training data across all the participating UEs. Therefore, data heterogeneity is a common problem in FL-based training processes because training data that is not independently and identically distributed (non-i.i.d) at FL UEs can cause problems of under-representation or over-representation, and reduce the convergence speed and model accuracy. For example, one common problem resulting from non-i.i.d. training data is referred to as the “Gradient Diversity” problem in which the gradient diversity of the AI/ML models from different devices reduces convergence speed and/or reduces the accuracy of the global AI/ML model. For example, when the gradient diversity is too large, the AI/ML model weights from different UEs may be updated towards different directions (e.g. UE1: +X, UE2: −X, FL avg: 0). As a result, using a traditional model averaging method such as federated averaging (FedAvg) can be problematic.

Federated Learning with UE Clustering

Cluster-based federated learning schemes have been proposed as a way to address the data heterogeneity problem. Such schemes propose separating UEs into UE clusters based on the similarity of their training data distributions (e.g. based on the similarity between UEs' local updates and global models) such that UEs with similar correlation between local gradients and global gradients are assigned into the same cluster. In such schemes, for each cluster, the BS and the UE(s) in the cluster collaboratively train a cluster-specific AI/ML model.

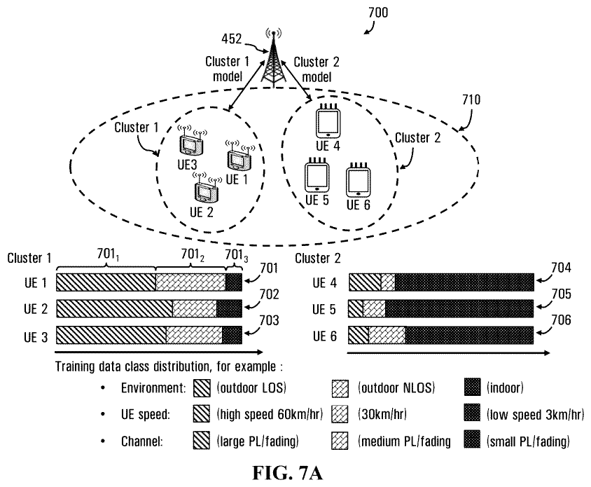

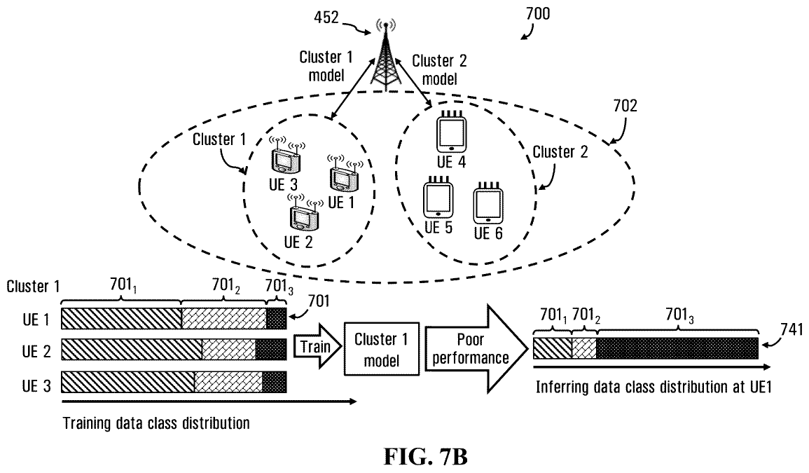

FIG. 7A illustrates an example of a communication system 700 in which a cluster-based federated learning process for AI/ML model training is being used, wherein a group of UEs participating in the federated learning process are clustered (i.e., separated into clusters) based on their training data class distributions and a cluster-specific AI/ML model is trained for each cluster.

The communication system 700 includes a network device 452 and a group of UEs 710 that includes six UEs identified as UE 1, UE 2, UE 3, UE 4, UE 5 and UE 6, respectively. The respective training data class distributions for UE 1, UE 2, UE 3, UE 4, UE 5 and UE 6 are indicated at 701, 702, 703, 704, 705 and 706, respectively. The different patterns within a given UE's training data class distribution indicate different data classes. In this example, each training data class distribution includes three data classes, e.g., the training data class distribution 701 of UE 1 includes a first data class 701₁, a second data class 701₂ and a third data class 701₃. The respective length of a given data class indicates the probability of that class in the training dataset of the corresponding UE. For example, the length of the first data class 701₁ represents the probability of the first data class 701₁ in the training dataset of UE 1. It is noted that the data classes may be based on different UE conditions. For example, the training data classes may be representative of different environment classes, different UE speed classes, different channel state classes, and the like. For example, as indicated in FIG. 7A, the different data classes may be representative of different environment conditions, such as an outdoor line of sight (LOS) condition, an outdoor non-line of sight (NLOS) condition, and an indoor NLOS condition. As another non-limiting example, the different data classes may also or instead be representative of different UE speed conditions, such as a high speed condition (e.g., 60 km/hr), a medium speed condition (e.g., 30 km/hr), and a low speed condition (e.g., 3 km/hr). As yet another non-limiting example, the different data classes may also or instead be representative of different communication channel conditions, such as a large pathloss (PL) or fading channel condition, a medium PL or fading channel condition, and a small PL or fading channel condition.

In this example, the UEs in the group 710 have been separated into two clusters (identified as Cluster 1 and Cluster 2, respectively) based on the similarity of their training data class distributions such that Cluster 1 includes UE 1, UE 2 and UE 3, and Cluster 2 includes UE 4, UE 5 and UE 6.

The data class distributions 701, 702 and 703 of UE 1, UE2 and UE3 in Cluster 1 have more of the first two data classes than the third data class. For example, the training data class distribution 701 of UE 1 indicates that the training dataset of UE 1 has more data in the first two data classes 701₁ and 701₂ than in the third data class 701₃. In contrast, the data class distributions 704, 705 and 706 of UE 4, UE 5 and UE 6 in Cluster 2 have more of the third data class than the first two data classes. In operation, each cluster has a cluster-specific AI/ML model and each cluster-specific AI/ML model is trained separately by the BS in collaboration with the UEs in the corresponding cluster. This is intended to address the data heterogeneity problem because the UEs in a given cluster have similar data class distributions.

However, there are several potential problems in existing cluster-based FL processes.

A first problem (hereinafter referenced as “Problem #1”) that can occur in existing cluster-based FL processes is related to differences between the class distribution of a UE's inferring dataset (i.e., the class distribution of the data that the UE uses as input to its trained cluster-specific AI/ML model) relative to the class distribution of the UE's training dataset (i.e., the class distribution of the data that the UE used as input to train its cluster-specific AI/ML model). If the difference between the UE's inferring data class distribution and the UE's training data class distribution is significant, the cluster-specific AI/ML model that the UE helped to collaboratively train may no longer be suitable for the UE (i.e., inferences generated by the UE's trained cluster-specific AI/ML model may not be sufficiently reliable/accurate). Such differences between a UE's inferring data class distribution and training data class distribution can arise, for example, when the radio environment in which the UE is operating is changed. For example, FIG. 7B shows an example in which the radio environment in which UE 1 is operating has changed such that the UE's inferring data class distribution, which is indicated at 741 in FIG. 7B, includes more data in the third data class 701₃ than the first two data classes 701₁ and 701₂, and as a result the accuracy of the cluster-specific AI/ML model for Cluster 1 (i.e., Cluster 1 model) will be decreased for UE 1. For example, if a cluster-specific AI/ML model is trained for the purpose of AI channel prediction based on training data having mostly good channel quality (e.g., a training dataset having a training data class distribution such as the training data class distribution 701 of UE 1, which has more training data in the first two data classes 701₁ and 701₂ than in the third data class 701₃), and the channel status of a UE in the cluster changes such that the UE experiences poor channel quality (e.g., the UE's inferring dataset has an inferring data class distribution such as the inferring data class distribution 741 of UE 1, which has more inferring data in the third data class 701₃ than in the first two data classes 701₁ and 701₂), then the cluster-specific model may no longer be suitable for that UE.

A second problem (hereinafter referenced as “Problem #2”) in existing cluster-based FL processes is related to the amount of communication overhead in a learning iteration. In particular, relative to existing non-cluster-based FL processes, existing cluster-based FL processes nominally utilize N times the communication overhead, where N is the number of clusters, because each cluster is trained separately and therefore additional overhead is incurred for each additional cluster. In particular, in traditional FL processes, only one global model is broadcast in the downlink to the participating devices. In contrast, in existing cluster-based FL processes, a separate cluster-specific model is groupcast to each cluster.

A third problem (hereinafter referenced as “Problem #3”) that can occur in existing cluster-based FL processes is related to scenarios in which UEs' data is not strongly non-i.i.d., because in such scenarios there is generally no material improvement in the convergence speed of existing cluster-based FL processes relative to non-cluster-based FL processes. On the contrary, clustering deprives UEs of access to more data from UEs in other clusters that may have some shared features with them. Therefore, for low or moderate non-i.i.d. cases, existing cluster-based FL processes can have poorer performance (e.g., reduced convergence speed and increased communication overhead) than existing non-cluster-based FL processes.

From the foregoing, it can be seen that existing cluster-based FL processes and non-cluster-based FL processes both synchronous FL and asynchronous FL have their own drawbacks.

Other than FL, large communication overhead and large learning delay also exists in other learning methods. For example, in distributed learning, UEs and a network device collaboratively train AI models in a manner similar to FL. The primary difference between FL and distributed learning being that in FL the DL transmissions are done via broadcast or groupcast transmissions, whereas unicast transmissions are used for DL in distributed learning.

The present disclosure describes examples of cluster-based AI/ML model training procedures that avoid or at least mitigate one or more of the foregoing problems with conventional AI/ML model training procedures. For example, as discussed in further detail below, in some embodiments described herein different techniques are used to configure UEs and a network device to collaboratively participate in a multi-stage AI/ML model training process utilizing cascaded AI/ML models. For example, a first aspect of the present disclosure provides a personalized cascaded AI/ML model comprising a common AI/ML sub-model and a cluster AI/ML sub-model that are cascaded such that an output of the common AI/ML sub-model is an input of the cluster AI/ML sub-model or vice versa. The common AI/ML sub-model is common to all devices participating in the AI/ML model training process and each cluster of devices within that group has its own cluster-specific cluster AI/ML sub-model. A second aspect of the present disclosure provides a multi-stage or multi-mode AI/ML model training process for training personalized cascaded AI/ML models. A third aspect of the present disclosure provides two-stage DCI for conveying UE-specific and/or cluster-specific control information to participating UEs during the multi-stage AI/ML model training process. For example, in some embodiments the two-stage DCI provided herein may be for cluster AI/ML sub-model indications, for cluster merging indications and/or for cluster switching indications, as discussed in further detail below.

It should be noted that although many of the following examples are described in the context of federated learning-based AI/ML model training procedures, the techniques described herein can also be applied to or distributed learning-based AI/ML model training procedures.

### Personalized Cascaded Model

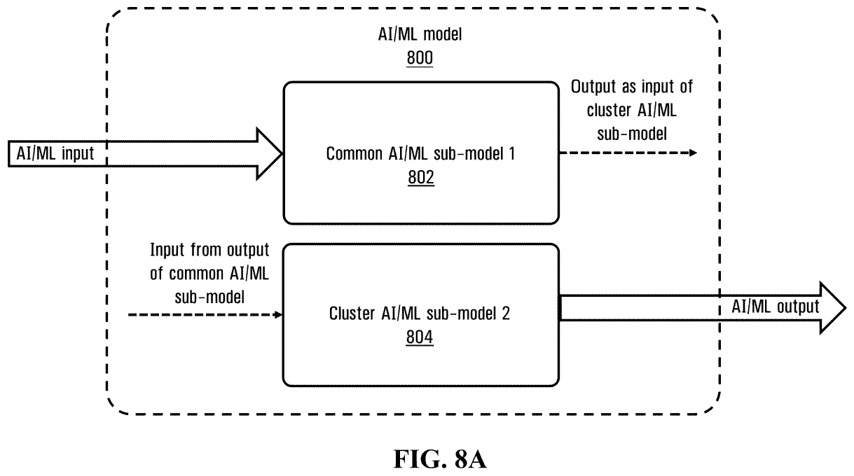

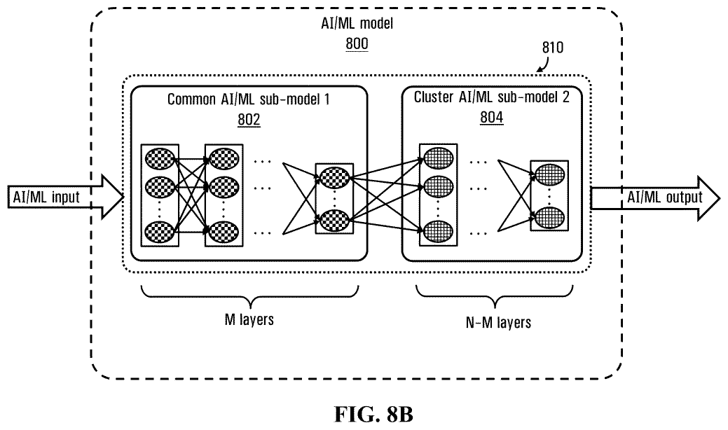

As noted above, one aspect of the present disclosure provides a personalized cascaded AI/ML model comprising a common AI/ML sub-model and a cluster AI/ML sub-model that are cascaded such that an output of the common AI/ML sub-model is an input of the cluster AI/ML sub-model or vice versa. The features of the common sub-model are shared and trained by all devices participating in the AI/ML model training process. In contrast, the features of the cluster AI/ML sub-model are shared and trained by the devices in a cluster corresponding to that cluster AI/ML sub-model. In other words, each cluster of devices within the total group of devices participating in the AI/ML model training process has its own cluster-specific cluster AI/ML sub-model. The common AI/ML sub-model and the cluster AI/ML sub-model may be implemented as separate AI/ML models that are cascaded or as one multi-layer AI/ML model (e.g., a deep neural network). For example, FIG. 8A illustrates an example of an AI/ML model 800 in accordance with one embodiment of the present disclosure in which a common AI/ML sub-model 1802 and a cluster AI/ML sub-model 2 804 are implemented as separate AI/ML models that are cascaded such that an output of the common AI/ML sub-model 1802 is an input of the cluster AI/ML sub-model 2 804. On the other hand, FIG. 8B illustrates an example of the AI/ML model 800 in accordance with another embodiment of the present disclosure in which the common AI/ML sub-model 1 802 and the cluster AI/ML sub-model 2 804 are implemented as one multi-layer AI/ML model 810 having N total layers in which the first M layers of the multi-layer AI/ML model 810 implement the common AI/ML sub-model 1 802 and the remaining N-M layers implement the cluster-specific cluster AI/ML sub-model 2 804.

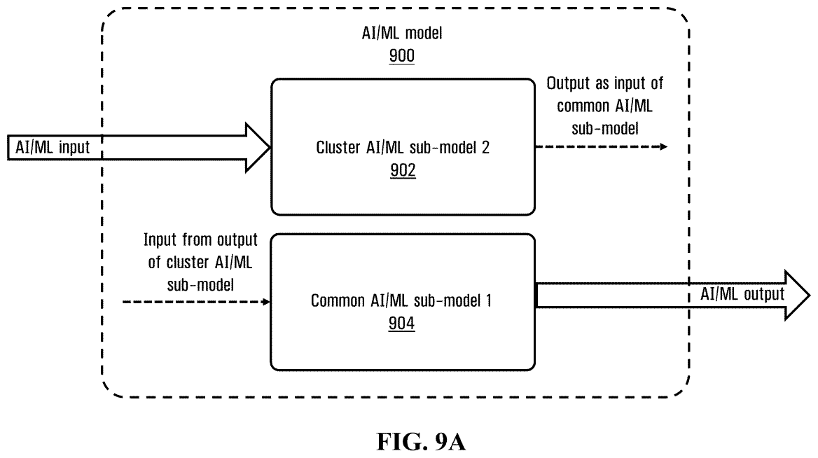

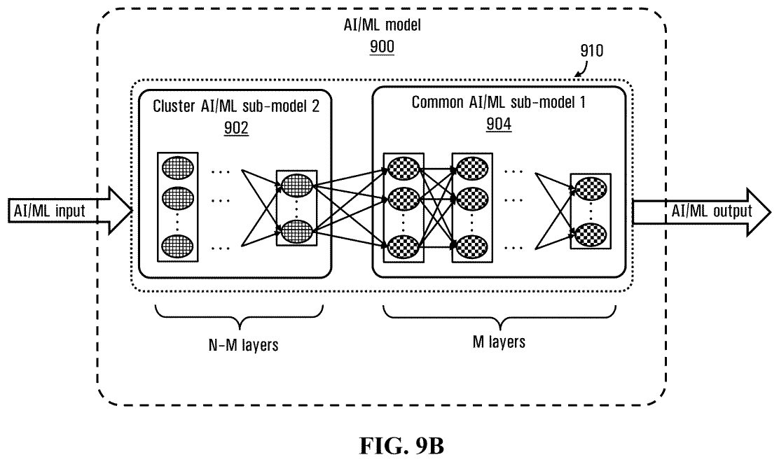

In the examples illustrated in FIGS. 8A and 8B, the common AI/ML sub-model 1802 and the cluster AI/ML sub-model 2 804 are cascaded such that an output of the common AI/ML sub-model 1802 is an input of the cluster AI/ML sub-model 2 804. However, as noted above, in other embodiments the sub-models may be cascaded in the opposite order, such that an output of the cluster AI/ML sub-model is an input of the common AI/ML sub-model. FIGS. 9A and 9B illustrate examples of such embodiments. In particular, FIG. 9A illustrates an example of an AI/ML model 900 in accordance with an embodiment of the present disclosure in which a cluster AI/ML sub-model 2 902 and a common AI/ML sub-model 1 904 are implemented as separate AI/ML models that are cascaded such that an output of the cluster AI/ML sub-model 2 902 is an input of the common AI/ML sub-model 1 904. On the other hand, FIG. 9B illustrates an example of the AI/ML model 900 in accordance with another embodiment of the present disclosure in which the cluster AI/ML sub-model 2 902 and the common AI/ML sub-model 1 904 are implemented as one multi-layer AI/ML model 910 having N total layers in which the first N-M layers of the multi-layer AI/ML model 910 implement the cluster AI/ML sub-model 2 902 and the last M layers implement the common AI/ML sub-model 1 904.

There are several potential benefits to utilizing a cascaded AI/ML model as disclosed herein. For example, because the features of the global common AI/ML sub-model can be shared and trained by all devices participating in the training process, the common features of the common AI/ML sub-model can be quickly converged, which solves or at least mitigates the third problem associated with existing cluster-based FL training processes that was discussed above (i.e., Problem #3: reduced convergence speed caused by clustering in existing cluster-based FL training processes). In addition, the parameters of the common AI/ML sub-model can be broadcast to all device, which reduces the DL overhead of cluster-specific groupcast transmissions relative to the DL overhead required by the cluster-specific groupcast transmissions in existing cluster-based FL training processes. In particular, because the parameters of the common AI/ML sub-model can be broadcast to all device, the parameters of the common AI/ML sub-model do not need to be included in the cluster-specific groupcast transmissions that are used to convey the parameters of the cluster-specific cluster AI/ML sub-model for each cluster. In other words, for each cluster, only the parameters of the corresponding cluster AI/ML sub-model may be groupcast to the cluster, which solves or at least mitigates the second problem associated with existing cluster-based FL training processes that was discussed above (i.e., Problem #2: high DL communication overhead in existing cluster-based FL training processes). Moreover, because a cluster-specific cluster AI/ML sub-model can be individually trained for each cluster of devices, the non-i.i.d/data heterogeneity problem in existing non-cluster based FL training processes is solved or at least mitigated by utilizing a cascaded AI/ML model that includes cascaded common and cluster-specific sub-models as disclosed herein.

Multi-stage Federated Learning with Cascaded AI/ML model

As noted above, a second aspect of the present disclosure provides a multi-stage or multi-mode AI/ML model training process for training personalized cascaded AI/ML models. As discussed in further detail below, the behavior of the devices participating in the training process is different in different stages/modes, and the network device that is coordinating the training process may indicate the devices switch to another stage/mode by control signalling, e.g., by RRC/MAC-CE/DCI signalling. The network device may also or instead use control signalling to indicate that two or more clusters are merged into a new cluster and/or that a specific device is switched to a different cluster, as discussed in further detail below with reference to the two-stage DCI framework provided by the third aspect of the present disclosure.

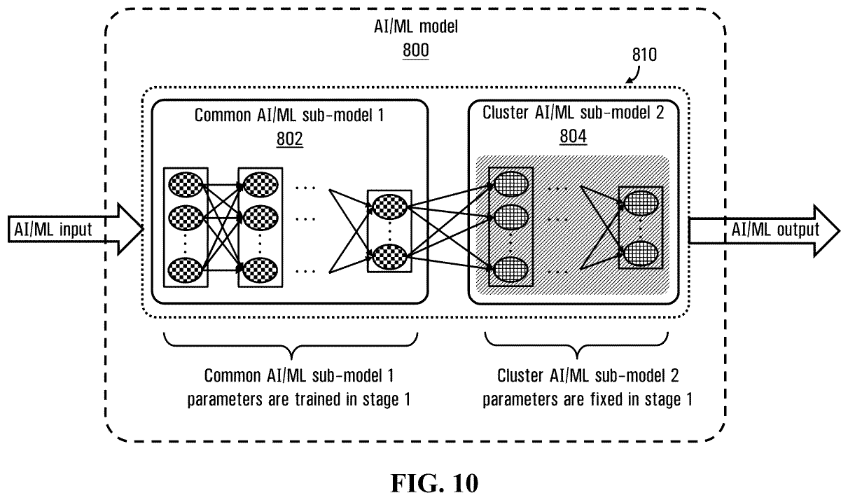

In such embodiments, the AI/ML model training process may include a first stage in which the parameters of the cluster AI/ML sub-model are fixed and all devices participating in the training process collaboratively train the common AI/ML sub-model. For example, FIG. 10 illustrates an example of the two cascaded sub-models 802,804 of the AI/ML model 800 of FIG. 8A during the first stage of a multi-stage AI/ML model training process according to one embodiment. As shown in FIG. 10, in the first stage, the parameters of the common AI/ML model 802 are trained and the cluster AI/ML sub-model 2 804 is fixed (i.e., not trained).

The network device coordinating the training process, e.g., a BS or TRP, informs the initial common and cluster sub-models to the participating devices, e.g., UEs, before or at the beginning of the training process. As noted above, in this first stage/mode, the parameters of the cluster sub-model/layers are fixed and all participating devices train the common sub-model/layers. In some cases, the network device may transmit training activation signalling to indicate that the devices are to operate in the first stage/mode. In the first stage/mode, the participating devices cascading the two sub-models and performs training to update the cascaded model, wherein the parameters of the cluster sub-model are fixed, i.e. no training for the cluster sub-model, each device only trains the common sub-model, and reports parameters of its updated local common sub-model to the network device. The network device may then aggregate the updated parameters reported by the devices participating in the training process and update the global common AI/ML sub-model. The aforementioned procedure is one iteration of the training process. The network device may then initiate a second iteration by transmitting the updated global common AI/ML sub-model parameter information to the participating devices. A unified group common RNTI may be used for this update. A group common RNTI that is not limited to a specific purpose, or that has multiple purposes, is also referred to herein as a unified group common RNTI. For example, a CRC value of the DCI scheduling the downlink transmission of the global common AI/ML sub-model parameter information may be scrambled by a unified group common RNTI. In which case, the participating devices use the unified group common RNTI in order to decode, i.e., descramble, the DCI in order to retrieve the scheduling information for the downlink transmission.

In the first stage, a participating device may also report to the network device correlation information that indicates correlation between the DL indicated common sub-model that was received from the network device and its local common sub-model. For example, the correlation information may include information indicating a gradient correlation for some layers of the common sub-model. The layers for which such gradient correlation information is reported may be predefined or configured. The correlation information may be reported to the network device on a periodic or aperiodic basis. The correlation information may be used by the network device to assist its clustering decision, e.g., the network device may cluster devices based on the similarity of their reported correlation information.

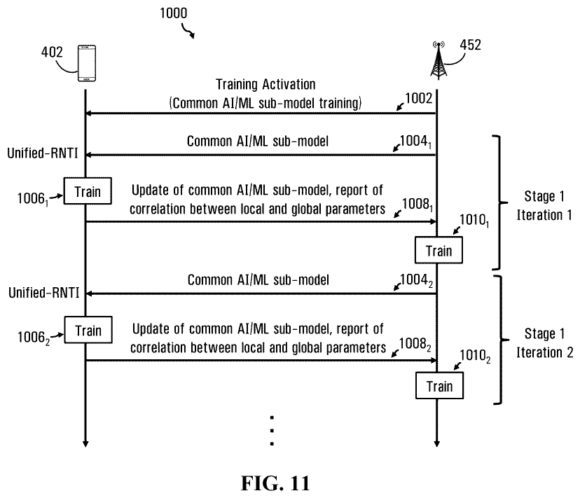

FIG. 11 illustrates an example signal flow diagram 1000 between an ED and a network device, e.g. a UE 402 and a TRP 452, for two iterations of a first stage of a multi-stage AI/ML model training process according to one embodiment. For simplicity and to avoid congestion in the drawing, only one UE 402 and one TRP 452 are shown in FIG. 11.

In the example shown in FIG. 11, UE 402 may operate in the first stage/mode by default at the start of the training procedure. In this example, the TRP 452 indicates the start of the training process by transmitting a training activation signal at 1002. The training activation signal could be indicated by TRP 452 through RRC, MAC-CE, or DCI signaling, for example. For example, TRP 452 could send a DCI with a CRC that is scrambled by an RNTI that is specific to AI/ML training signaling, e.g., AI-training-RNTI, to activate the training procedure. For example, some specific fields in the DCI could be set as predefined values to indicate training activation, e.g. fields of New data indicator, Redundancy version, HARQ process number, DAI, TPC for PUCCH, PUCCH resource indicator, or HARQ timing may be set to a predefined value that is understood to indicate that AI training is to be activated.

In the example shown in FIG. 11, after the first stage of the AI/ML training procedure has been activated by transmission of the training activation signal at 1002, TRP 452 and UE 402 begin a first iteration of the training process. In this example, the AI/ML training procedure is assumed to be an FL-based AI/ML training procedure in which TRP 452 and UE 402 iteratively exchange common AI/ML sub-model updates. For example, in the first iteration indicated as Iteration 1 in FIG. 11, TRP 452 transmits common AI/ML sub-model update information at 1004₁, which may include global common AI/ML sub-model parameters as discussed previously. As discussed previously, in federated learning the transmission of the global common AI/ML sub-model update information by TRP 452 at 1004₁ is a broadcast transmission that is broadcast to multiple UEs (including UE 402). Also as discussed previously, a unified RNTI may be used by UE 402 to receive the global common AI/ML sub-model update transmission at 1004₁.

At 1006₁, UE 402 initializes a local common AI/ML sub-model based on the global common AI/ML sub-model update information received at 1004₁ (e.g., using global common AI/ML sub-model parameters included in the global common AI/ML sub-model update information received at 1004₁), and trains its local common AI/ML sub-model using its own training data.

UE 402 may then transmit its own local common AI/ML sub-model update information at 1008₁ to report updated local common AI/ML sub-model parameters to TRP 452. As discussed previously, UE 402 may also report correlation information to TRP 452 that indicates correlations between the global common AI/ML sub-model that was received from the network device and its local common AI/ML sub-model. For example, the correlation information may include information indicating a gradient correlation for some layers of the common AI/ML sub-model.

At 1010₁, TRP 452 may then aggregate the updated parameters reported from UE 402 and those reported by other UEs participating in the FL-based training procedure and update the global common AI/ML sub-model. The aforementioned procedure is one iteration of the first stage of the FL-based AI/ML model training procedure, which in this example includes multiple iterations. For example, in the example depicted in FIG. 11, TRP 452 initiates a second iteration by transmitting updated global common AI/ML sub-model update information at 1004₂. Similar to the first iteration (Iteration 1), in the second iteration indicated at Iteration 2 in FIG. 11, UE 402 then updates its local common AI/ML sub-model based on the global common AI/ML sub-model update information received at 1004₂, trains its local common AI/ML sub-model using its own data at 1006₂, and transmits its own common AI/ML sub-model update information to TRP 452 at 1008₂. At 1010₂, TRP 452 may then aggregate the updated parameters reported from UE 402 and any other UEs participating in the FL-based training procedure and again update the global common AI/ML sub-model, and so on.

Subsequent training iterations may continue in the first stage and TRP 452 may monitor the progress of the first stage of the AI/ML model training procedure to determine whether the global common AI/ML sub-model has converged sufficiently to satisfy one or more training goals/criteria, e.g., TRP 452 may check for convergence after each iteration in the first stage. Once the training goals/criteria for the first stage have been satisfied, TRP 452 may activate a second stage of the AI/ML model training process in which parameters of the cluster AI/ML sub-model are trained, as discussed in further detail below.

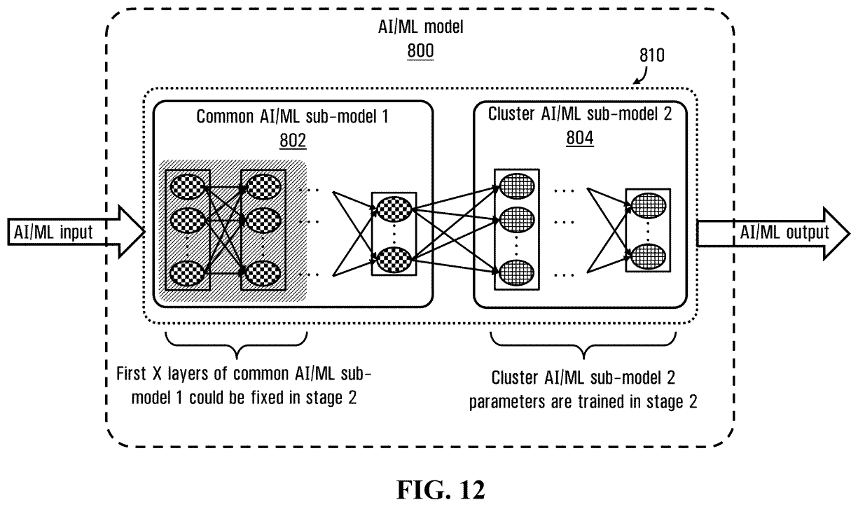

In a second stage of the AI/ML model training process, the network device that is coordinating the training process may divide the participating devices into multiple clusters (e.g., based on reports of correlation between the global AI/ML model and each device's local AI/ML model during the first stage), and the devices in each cluster start to train their cluster-specific cluster AI/ML sub-model. For example, FIG. 12 illustrates an example of the two cascaded sub-models 802,804 of the AI/ML model 800 of FIG. 8A during the second stage of a multi-stage AI/ML model training process according to one embodiment. As shown in FIG. 12, the parameters of the cluster AI/ML sub-model 2 804 are trained in the second stage. In some embodiments, devices continue to train the common AI/ML sub-model, or at least some portion of the common AI/ML sub-model, in the second stage. For example, as shown in FIG. 12, some parameters of the common AI/ML sub-model may be fixed (i.e., not trained) in the second stage (e.g., the parameters of the first X layers of the common AI/ML sub-model may be fixed in the second stage of the training process), while other parameters of the common AI/ML sub-model continue to be trained in the second stage. In other embodiments, a UE does not train the common AI/ML sub-model in the second stage. The configuration to either continue or stop training the common AI/ML sub-model in the second stage could be predefined or configured/indicated by the network device.

The network device that is coordinating the training process indicates that the participating devices are to switch to the second stage by transmitting signalling, e.g., through RRC/MAC-CE/DCI signalling. In addition, the network device transmits signalling (e.g., by RRC/MAC-CE/DCI signalling) to configure a cluster-specific RNTI, different from the unified-RNTI, for each cluster of devices, e.g. cluster-i-RNTI, which is specific to a cluster of devices. The cluster-specific RNTI for a given cluster is used by the devices in that cluster for reception of the cluster AI/ML sub-model update information transmitted by the network device.

In the second stage, participating devices use the unified RNTI for receiving common AI/ML sub-model updates from the network device, and use the cluster specific RNTI corresponding to the cluster that the device belongs to for receiving cluster AI/ML sub-model updates from the network device. For example, a device that is included in cluster i would utilize cluster-i-RNTI for receiving cluster AI/ML sub-model updates from the network device. In this stage, a participating device may separately report its local common AI/ML sub-model update and its local cluster AI/ML sub-model update (e.g. by two reports), or may include the updates in one report. Reporting separately or by one report may be done in accordance with a predefined rule or could be configured by the network device.

In the second stage, a participating device may report correlation information that indicates correlation between the DL indicated cluster AI/ML sub-model that was received from the network device and its local cluster AI/ML sub-model. The correlation information may be used by the network device to assist in making cluster merging/switching decisions at the network device. In the second stage, a participating device may also or instead report correlation information that indicates correlation between the DL indicated common AI/ML sub-model that was received from the network device and its local common AI/ML sub-model, or that indicates the correlation between the DL indicated cascaded AI/ML model that was received from the network device and its local cascaded AI/ML model.

To reduce the UL overhead for common AI/ML sub-model report, the network device that is coordinating the training process could dynamically indicate that some subset of the parameters of the common AI/ML sub-model, such as the parameters of the first X layers of the common AI/ML sub-model, are fixed in the second stage, and there is therefore no need for updating and reporting those parameters/layers.

After receiving the device's report of the local parameters update and the correlations, the network device performs its model update at BS side, and starts a subsequent iteration.

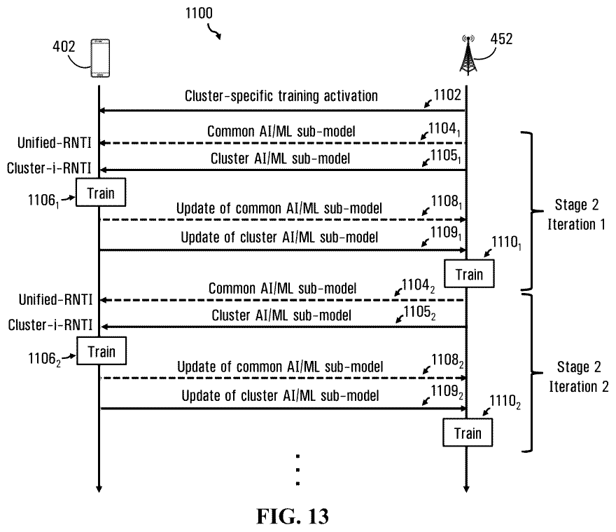

FIG. 13 illustrates an example signal flow diagram 1100 between an ED and a network device, e.g., a UE 402 and a TRP 452, for two iteration of a second stage of a multi-stage AI/ML model training process according to one embodiment. For simplicity and to avoid congestion in the drawing, only one UE 402 and one TRP 452 are shown in FIG. 13.

In the example shown in FIG. 13, TRP 452 indicates the start of the second stage of the training process by transmitting a cluster-specific training activation signal at 1102. The cluster-specific training activation signal could be indicated by TRP 452 through RRC, MAC-CE, or DCI signaling, for example.

In the example shown in FIG. 13, after the second stage of the AI/ML training procedure has been activated by transmission of the training activation signal at 1102, TRP 452 and UE 402 begin a first iteration of the second stage of the training process. In this example, the AI/ML training procedure is assumed to be an FL-based AI/ML training procedure in which TRP 452 and UE 402 iteratively exchange common AI/ML sub-model updates. For example, in the first iteration indicated as Iteration 1 in FIG. 13, TRP 452 transmits common AI/ML sub-model update information at 1104₁, and transmits cluster AI/ML sub-model update information at 1005₁. As shown in FIG. 13, a unified RNTI may be used by UE 402 to receive the global common AI/ML sub-model update transmission at 1004₁ and a cluster specific RNTI (e.g., Cluster-i-RNTI) may be used by UE 402 to receive the global cluster AI/ML sub-model update transmission at 1005₁. In some embodiments, a two-stage DCI may be used to schedule the transmissions of the global common AI/ML sub-model update transmission at 1004₁ and the global cluster AI/ML sub-model update transmission at 1005₁, as discussed in further detail below.

At 1106₁, UE 402 updates its local common AI/ML sub-model based on the global common AI/ML sub-model update information received at 1004₁, updates its local cluster AI/ML sub-model based on the global cluster AI/ML sub-model update information received at 1005₁, and trains its local cascaded AI/ML model using its own training data.

UE 402 may then transmit its own local common AI/ML sub-model update information at 1108₁ to report updated local common AI/ML sub-model parameters to TRP 452. Similarly, UE 402 may transmit its own local cluster AI/ML sub-model update information at 1109₁ to report updated local cluster AI/ML sub-model parameters to TRP 452. Although these two updates are shown as being separately reported in FIG. 13, in other embodiments the common AI/ML sub-model update information and the cluster AI/ML sub-model update information may be included in one report. As discussed previously, UE 402 may also report correlation information to TRP 452 that indicates correlations between correlation information that indicates correlation between the DL indicated cluster AI/ML sub-model that was received from the network device at 1105₁ and its local cluster AI/ML sub-model.

At 1110₁, TRP 452 may then aggregate the updated parameters reported from UE 402 and those reported by other UEs participating in the FL-based training procedure and update the global common AI/ML sub-model and the global cluster AI/ML sub-model. The aforementioned procedure is one iteration of the second stage of the FL-based AI/ML model training procedure, which in this example includes multiple iterations. For example, in the example depicted in FIG. 13, TRP 452 initiates a second iteration by transmitting updated global common AI/ML sub-model update information at 1104₂ and global cluster AI/ML sub-model update information at 1105₂. Similar to the first iteration (Iteration 1), in the second iteration indicated at Iteration 2, UE 402 then updates its local common AI/ML sub-model and its local cluster AI/ML sub-model, trains its local cascaded AI/ML model using its own data at 1106₂, and transmits its own common AI/ML sub-model update information and cluster AI/ML sub-model update information to TRP 452 at 1108₂ and 1109₂, respectively. At 1110₂, TRP 452 may then aggregate the updated parameters reported from UE 402 and any other UEs participating in the FL-based training procedure and again update the global common AI/ML sub-model and the global cluster AI/ML sub-model, and so on.

As noted above, in some embodiments the common AI/ML sub-model may be fixed (i.e., not trained) in the second stage. In such embodiments, UE 402 does not train its local common AI/ML sub-model at 1106₁ and 1106₂, and does not provide common AI/ML sub-model update reports at 1108₁ and 1108₂. Similarly, in such embodiments TRP 452 may not provide common AI/ML sub-model update information at 1104₁ and 1104₂.

Subsequent training iterations may continue in the second stage and TRP 452 may monitor the progress of the second stage of the AI/ML model training procedure to determine whether the global cluster AI/ML sub-model has converged sufficiently to satisfy one or more training goals/criteria, e.g., TRP 452 may check for convergence after each iteration in the second stage. Once the training goals/criteria for the second stage have been satisfied, TRP 452 may activate a third stage of the AI/ML model training process, as discussed in further detail below.

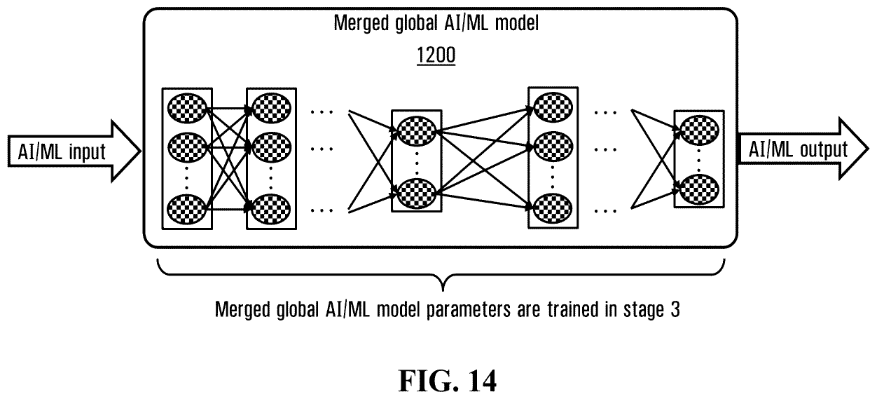

In a third stage of the AI/ML model training process, the network device merges the common AI/ML sub-model and the cluster AI/ML sub-models into a unified global AI/ML model and starts the unified global AI/ML model training, which may proceed in a manner similar to existing non-clustered FL or DL training processes. For example, FIG. 14 illustrates an example of a merged global AI/ML model 1200 during a third stage of a multi-stage AI/ML model training process according to one embodiment. As shown in FIG. 14, the parameters of the merged global AI/ML model 1200 are trained in the third stage.

In the third stage, the network device that is coordinating the training process merges the common AI/ML sub-model and cluster AI/ML sub-models to form one unified global AI/ML model. For example, at a late stage of the cluster sub-model training in the second stage, the network device could perform model merging for multiple clusters into one global model, which solves or at least mitigates the first problem associated with existing cluster-based FL training processes that was discussed earlier (i.e., Problem #1: inferring data distribution is different from the training data).

The network device that is coordinating the training process indicates that the participating devices are to switch to the third stage by transmitting signalling, e.g., through RRC/MAC-CE/DCI signalling. For example, the network device may transmit a cluster training de-activation signal to trigger a switch from the second stage (i.e, the cluster AI/ML sub-model training stage) to the third stage (i.e, the merged global AI/ML model training stage). The network device also send the merged global AI/ML model to the participating device.

In the third stage, participating devices use the unified RNTI for receiving merged global AI/ML model updates from the network device. The participating devices also stop training the cascaded AI/ML models (including the common and cluster AI/ML sub-models), and start training the merged global AI/ML model. In addition, participating devices stop reporting the correlation between the network device's global AI/ML model or sub-models and the device's local AI/ML model or sub-models.

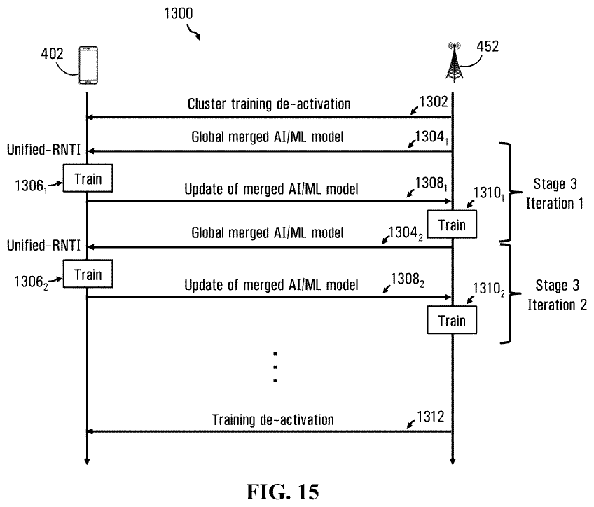

FIG. 15 illustrates an example signal flow diagram 1300 between an ED and a network device, e.g. a UE 402 and a TRP 452, for two iterations of a third stage of a multi-stage AI/ML model training process according to one embodiment. For simplicity and to avoid congestion in the drawing, only one UE 402 and one TRP 452 are shown in FIG. 13.

In the example shown in FIG. 15, the TRP 452 indicates the end of the second stage and the start of the third stage of the training process by transmitting a cluster training de-activation signal at 1302. The cluster training de-activation signal could be indicated by TRP 452 through RRC, MAC-CE, or DCI signaling, for example.

In the example shown in FIG. 15, after the third stage of the AI/ML training procedure has been activated, TRP 452 and UE 402 begin a first iteration of the third stage of the training process. In this example, the AI/ML training procedure is assumed to be an FL-based AI/ML training procedure in which TRP 452 and UE 402 iteratively exchange merged global AI/ML model updates. For example, in the first iteration indicated as Iteration 1 in FIG. 15, TRP 452 transmits global merged AI/ML model update information at 1304₁, which may include global merged AI/ML model parameters as discussed previously. As discussed previously, in federated learning the transmission of the global merged AI/ML model update information by TRP 452 at 1304₁ is a broadcast transmission that is broadcast to multiple UEs (including UE 402) and a unified RNTI may be used by the UEs (including UE 402) to receive the global merged AI/ML model update transmission.

At 1306₁, UE 402 initializes a local merged AI/ML model based on the global merged AI/ML model update information received at 1304₁ (e.g., using global merged AI/ML model parameters included in the global merged AI/ML model update information received at 1304₁), and trains its local merged AI/ML model using its own training data.

UE 402 may then transmit its own local merged AI/ML model update information at 1308₁ to report updated local merged AI/ML model parameters to TRP 452.

At 1310₁, TRP 452 may then aggregate the updated parameters reported from UE 402 and those reported by other UEs participating in the FL-based training procedure and update the global merged AI/ML model. The aforementioned procedure is one iteration of the third stage of the FL-based AI/ML model training procedure, which in this example includes multiple iterations. For example, in the example depicted in FIG. 15, TRP 452 initiates a second iteration by transmitting updated global merged AI/ML model update information at 1304₂. Similar to the first iteration (Iteration 1), in the second iteration indicated at Iteration 2, UE 402 then updates its local merged AI/ML model based on the global merged AI/ML model update information received at 1304₂, trains its local merged AI/ML model using its own data at 1306₂, and transmits its own merged AI/ML model update information to TRP 452 at 1308₂. At 1310₂, TRP 452 may then aggregate the updated parameters reported from UE 402 and any other UEs participating in the FL-based training procedure and again update the global merged AI/ML model, and so on.

Subsequent training iterations may continue in the third stage and TRP 452 may monitor the progress of the third stage of the AI/ML model training procedure to determine whether the global merged AI/ML model has converged sufficiently to satisfy one or more training goals/criteria, e.g., TRP 452 may check for convergence after each iteration in the third stage. Once the training goals/criteria for the first stage have been satisfied, TRP 452 may stop the training procedure by sending a training de-activation signal to the participating devices, as indicated at 1312 in FIG. 15. The training de-activation signal may be sent 452 through RRC, MAC-CE, or DCI signaling, for example.

As discussed above, the third stage of the AI/ML training process, which involves the merging of the global common AI/ML sub-model and the cluster AI/ML sub-models from multiple clusters of devices into one unified merged global AI/ML model could solve or at least mitigate the problem that can occur in existing cluster-based FL training process when a device's inferring data class distribution is significantly different from its training data class distribution. Another alternative to addressing this problem does not require model merging and third stage training. Instead, a network device may individually inform a device, e.g., a UE, of the available/suitable cluster sub-model that the device should use based on information provided by the device about its inferring data. For example, a UE may report its current status (e.g. inferring data labels, or correlation between training data and inferring data) to a network device before or when the UE performs AI inferring, then the network device may allocate the appropriate cluster sub-model to the UE based on its current status.

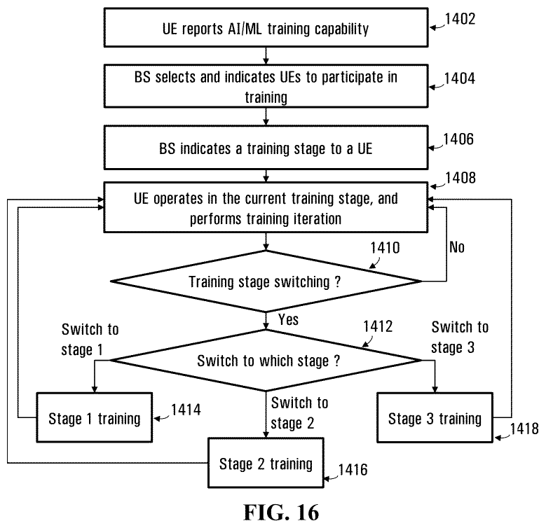

FIG. 16 illustrates an example of a flowchart for a multi-stage federated learning-based AI/ML model training process according to one embodiment. In this example, the devices involved are assumed to be a BS and UE.

In block 1402, the UE reports its AI/ML model training capability to the BS. For example, the AI/ML model training capability may be based on or include the AI/ML processing capability and/or training data volume for the UE and may be conveyed by sending an AI/ML model training capability level ID from among a hierarchy of AI/ML model training capability level IDs corresponding to different levels of AI/ML model training capability.

In block 1404, the BS, based on the AI/ML model training capabilities reported by the UE, selects and indicates the UEs that are to participate in the training.

In block 1406, the BS indicates a training stage to the UE. For example, the BS may explicitly indicate a training stage to the UE. Alternatively, the UE may be configured to operate in a given training stage/mode by default, and the BS may indicate that the UE is to begin operating in the given training stage by transmitting a training activation signal, such as the training activation signal transmitted at 1002 in FIG. 11. The training activation signal could be indicated through RRC, MAC-CE, or DCI signaling, for example.

In block 1408, the UE operates in the current training stage and performs a training iteration in accordance with the current training stage.

In block 1410, if the training stage has not changed, the process returns to block 1408 and the UE continues to operate in the current training stage. On the other hand, if the UE determines in block 1410 that the training stage is switching (e.g., in response to receiving signalling from the BS, such as the cluster-specific training activation signal 1102 in FIG. 13, which indicates a switch to the second training stage), then the process proceeds to block 1412 in which the UE determines which training stage to switch to. For example, if the UE receives a stage 1 training activation signal, such as the common AI/ML sub-model training activation signal 1002 in FIG. 11, the UE may switch to stage 1 training as indicated in block 1414 and the process returns to block 1408 in which the UE operates in stage 1. Alternatively, if the UE receives a stage 2 training activation signal, such as the cluster-specific training activation signal 1102 in FIG. 13, the UE may switch to stage 2 training as indicated in block 1416 and the process returns to block 1408 in which the UE operates in stage 2. On the other hand, if the UE receives a stage 2 training de-activation signal, such as the cluster training de-activation signal 1302 in FIG. 13, the UE may switch to stage 3 training as indicated in block 1418 and the process returns to block 1408 in which the UE then operates in stage 3.

### Two-Stage DCI Framework

As noted above, a third aspect of the present disclosure provides two-stage DCI for conveying UE-specific and/or cluster-specific control information to participating UEs during a multi-stage AI/ML model training process.

A DCI transports downlink control information for one or more cells/carriers/BWPs. DCI structure includes one-stage DCI and two-stage DCI. In one-stage DCI structure, the DCI has a single part and is carried on a physical channel, e.g. PDCCH. A UE receives the physical channel and decodes the DCI in the physical channel, then receives or transmits data according to the control information in the DCI.

In a two-stage DCI structure, the DCI structure includes two parts, i.e. first stage DCI and corresponding second stage DCI. The first stage DCI and the second stage DCI are transmitted in different physical channels, e.g. the first stage DCI is carried on a PDCCH and the second stage DCI is carried on a PDSCH, wherein the second stage DCI is not multiplexed with UE DL data, i.e. the second stage DCI is transmitted on a PDSCH without DL-SCH. The first stage DCI indicates control information for the second stage DCI, including time/frequency/spatial resources of the second stage DCI. Optionally, the first stage DCI can indicate the presence of the second stage DCI. If the second stage DCI is present, a UE needs to receive both the first stage and the second stage DCI to get the control information for data transmission. For the contents of the first stage DCI and second stage DCI, the first stage DCI includes the control information for the second stage DCI and the second stage DCI includes the control information for the UE data; or the first stage DCI includes the control information for the second stage DCI and partial control information for the UE data, and the second stage DCI includes partial or whole control information for the UE data. If the second stage DCI is not present, which may be indicated by the first stage DCI, a UE receives the first stage DCI to get the control information for data transmission.

In accordance with an embodiment of the present disclosure, a two-stage DCI framework is provided. The two-stage framework involves the use of a first stage DCI that is transmitted by the network device, for example by a base station, for reception by UE. The first stage DCI is carried by a PDCCH. The two-stage framework also involves the use of a second stage DCI that is transmitted by the network device for reception by UE. The second stage DCI is carried by a PDSCH without data transmission, or the second stage DCI is carried in a specific physical channel (e.g. a specific downlink data channel, or a specific downlink control channel) only for the second stage DCI transmission.

The second stage DCI is transmitted on PDSCH without downlink shared channel (DL-SCH), where the DL-SCH is a transport channel used for the transmission of downlink data. That is to say the physical resources of the PDSCH used to transmit the second stage DCI are used for a transmission including the second stage DCI without multiplexing with other downlink data. For example, where the unit of transmission on the PDSCH is a physical resource block (PRB) in frequency-domain and a slot in time-domain, an entire resource block in a slot is available for second stage DCI transmission. This allows maximum flexibility in terms of the size of the second stage DCI, without the constraints on the amount of DCI that could be transmitted that would be introduced if multiplexing with downlink data was employed. This also avoids the complexity of rate matching for downlink data if the downlink data is multiplexed with DCI.

The UE receives the first stage DCI (for example by receiving a physical channel carrying the first stage DCI) and performs decoding (e.g. blind decoding) to decode the first stage DCI. Scheduling information for the second stage DCI, within the PDSCH, is explicitly indicated by the first stage DCI. The result is that the second stage DCI can be received and decoded by the UE without the need to perform blind decoding, based on the scheduling information in the first stage DCI.

As compared to scheduling a PDSCH carrying downlink data, in some embodiments more robust scheduling information is used to schedule a PDSCH carrying second stage DCI, increasing the likelihood of that the receiving UE can successfully decode the second stage DCI. Detailed examples are provided below.

Because the second stage DCI is not limited by constraints that may exist for PDCCH transmissions, the size of the second stage DCI is very flexible, and may be used to indicate scheduling information for one carrier, multiple carriers, multi-transmissions for one carrier. Detailed examples are provided below.

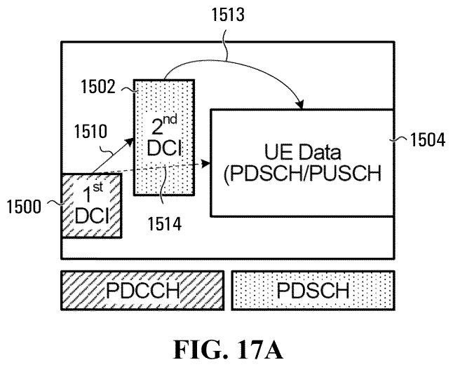

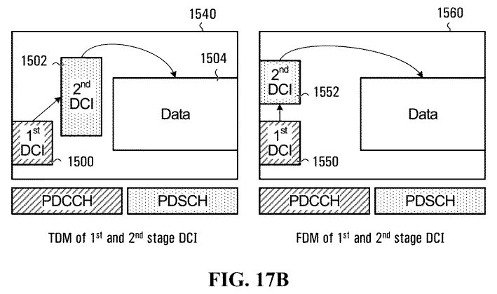

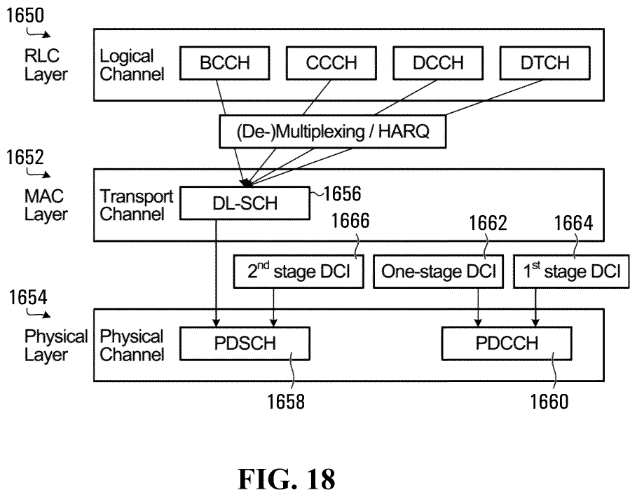

An example of the resources that might be used for the two-stage DCI is shown in FIG. 17A. In FIG. 17A, time domain (e.g., orthogonal frequency division multiplexing (OFDM) symbol durations) is in the horizontal axis, and frequency domain (e.g., OFDM subcarriers) is in the vertical direction. Shown is a first stage DCI 1500 transmitted using a PDCCH, where the PDCCH includes one or more control channel elements (CCEs) or enhanced CCEs, and a second stage DCI 1502 transmitted on a PDSCH using at least one of one or more PRBs, one or multiple transport block(s), and one or more symbols, the PDSCH uses for transmitting the second stage DCI 1502 only without any UE data transmission. One example of PDCCH and PDSCH structure can refer to the following FIG. 18. The first stage DCI 1500 includes a scheduling information of the second stage DCI 1502, depicted graphically by arrow 1510. Also shown is UE data 1504, which may include uplink data on a physical uplink shared channel (PUSCH) and/or downlink data on a PDSCH and/or a sidelink channel scheduled by the second stage DCI.

In some embodiments, scheduling information of the second stage DCI indicates parameters of at least one of a time resource, a frequency resource and a spatial resource of the second stage DCI. The first stage DCI may also indicate at least modulation order of the second stage DCI, coding rate of the second stage DCI, partial or full scheduling information for a data transmission.

The second stage DCI may include scheduling information for data channel, e.g. PDSCH for DL scheduling and/or PUSCH for uplink (UL) scheduling. Referring to FIG. 17A, for this case, arrow 1510 represents the indication of the time and/or frequency and/or spatial resources and/or modulation order and/or coding rate of the second stage DCI, and arrow 1513 represents the scheduling information for data transmission, e.g. DL scheduling for PDSCH and/or UL scheduling for PUSCH and/or sidelink resources for UE transmission or reception

In some embodiments, the first stage DCI indicates scheduling information of the second stage DCI, and also includes partial scheduling information for a data transmission, such as one or more of time/frequency/spatial resource allocation, modulation order, coding rate, HARQ information, UE feedback resources, or power control for data. The second stage DCI includes additional detailed scheduling information for data, e.g. the information not indicated by first stage DCI, or an update to the information indicated by first stage DCI for data. Referring to FIG. 17A, for this case, arrow 1510 represents the indication of the time and/or frequency and/or spatial resources and/or modulation order and/or coding rate of the second stage DCI. Arrow 1714 represents partial scheduling information for data transmission. Arrow 1513 represents the detailed scheduling information for data, e.g. DL scheduling for PDSCH and/or UL scheduling for PUSCH.

The first stage DCI is blind decoded by the UE. No blind decoding is required for the second stage DCI because the scheduling information of the second stage DCI is explicitly indicated by the first stage DCI.

A transport block defines the basic information bits unit transmitted in PDSCH/PUSCH. For PDSCH carrying downlink data, e.g. information bits from MAC layer, a MAC protocol data unit (PDU) is mapped to a TB. For PDSCH carrying the second stage DCI, the DCI is mapped to a TB. The transport block size (TBS) is defined as the size (number of bits) of a TB. Depending on definition, the TB size may include or exclude the CRC bits. While no TB from a medium access control (MAC) layer is transmitted in the PDSCH carrying the second stage DCI, the size of the second stage DCI may be determined in a manner similar to how TB size for DL-SCH transmitted using the PDSCH is calculated/determined. The TB size may be calculated, for example, based on the available resource elements (REs) for PDSCH, modulation order, coding rate, the number of layers, etc. Therefore, by assigning flexible RBs and symbols for the PDSCH, and using various coding rates for the DCI, the size of second stage DCI is very flexible, enabling DCI size to be specified differently for different uses, for example, different UEs, different services, different scenarios, etc., thus can achieve personalized DCI size requirements.

In some embodiments, the second stage DCI may indicate at least one of the following for scheduling data transmission for a UE:
scheduling information for one PDSCH in one carrier/BWP;
scheduling information for multiple PDSCH in one carrier/BWP;
scheduling information for one PUSCH in one carrier/BWP;
scheduling information for multiple PUSCH in one carrier/BWP;
scheduling information for one PDSCH and one PUSCH in one carrier/BWP;
scheduling information for one PDSCH and multiple PUSCH in one carrier/BWP;
scheduling information for multiple PDSCH and one PUSCH in one carrier/BWP;
scheduling information for multiple PDSCH and multiple PDSCH in one carrier/BWP;
scheduling information for sidelink in one carrier/BWP;
partial scheduling information for at least one PUSCH and/or at least one PDSCH in one carrier/BWP, wherein the partial scheduling information is an update to scheduling information in the first stage DCI;
partial scheduling information for at least one PUSCH and/or at least one PDSCH, wherein remaining scheduling information for the at least one PUSCH and/or at least one PDSCH is included in the first stage DCI;
configuration information related to an AI/ML function;
configuration information related to a non-AI/ML function.

Therefore, the two-stage DCI mechanism can be used to achieve a unified design for UEs with different AI/ML capabilities. The design is unified in the sense that the same DCI format for the first stage DCI can be used, while the scheduling information in the second stage DCI is flexible, and can be used to configure AI/ML functions. For example, for scheduling information included scheduling information in second stage DCI, which may include one or more of frequency/time domain resource allocation, modulation order, coding scheme, new data indicator, redundancy version, HARQ related information, transmit power control, PUCCH resource indicator, antenna port(s), transmission configuration indication, code block group indicator, pre-emption indication, cancellation indication, availability indicator, resource pool index, etc., the second stage DCI can include a dynamic indication whether the information is for a non-AI mode or an AI mode. When the AI mode has multiple AI types, the second stage DCI can include a dynamic indication indicating one of the multiple AI types. When an AI mode applies, the value in the scheduling information field is used as an input to an AI inference engine to determine the meaning.

For the time and frequency resources of first stage DCI and second stage DCI, they can be time division multiplexed and/or frequency division multiplexed, however in general, the first stage DCI will need to be decoded before the second stage DCI is decoded, as the UE is not aware of the second stage DCI until the first stage DCI is decoded. FIG. 17B shows a first example, generally indicated at 1540 (which shows the same resource usage as FIG. 17A), where first and second stage DCIs 1500,1502 are time division multiplexed. In some embodiments, where the frequency resource is the same for the first and second stage DCIs, the scheduling information of the second stage DCI included in the first stage DCI does not include information about a frequency resource.

FIG. 17B shows a second example, generally indicated at 1560, where first and second stage DCIs 1550,1552 are frequency division multiplexed. In this example, the first and second stage DCIs 1550,1552 are received at the same time or in overlapping frequency resources, the first stage DCI 1550 is decoded first, since the UE is not aware of the second stage DCI until having decoded the first stage DCI. In some embodiments, where the time resource is the same for the first and second stage DCIs, the scheduling information of the second stage DCI included in the first stage DCI does not include information about a time resource.

For all of the embodiments described herein, it is assumed that the first stage DCI is carried by a PDCCH and the second stage DCI is carried by a PDSCH. PDCCH is the physical channel that carries control information. PDSCH is the physical channel that carries DL-SCH originating from a higher layer and/or control information. The PDCCH transmission of the first stage DCI may include one or more control-channel elements (CCEs), or enhanced CCEs. The PDSCH transmission of the second stage DCI may occupy at least one of one or more PRBs in the frequency-domain, one or more TBs and one or more symbols in the time-domain. The processing procedure is similar to the downlink data processing.

Details of protocol stack are now described. The following discussion is equally applicable to the above PDCCH and PDSCH of any of the examples of FIGS. 17A and 17B. It should be understood that the PDCCH and PDSCH as disclosed herein, are not limited by the PDCCH and PDSCH of any of the examples of FIGS. 17A and 17B. Referring now to FIG. 18, shown is an example of a protocol stack that includes RLC (radio link control) layer 1650, MAC layer 1652 and physical layer 1654. RLC operates per logical channel, MAC operates per transport channel (e.g. downlink-shared channel (DL-SCH)) and physical layer operates per physical channel (e.g. PDSCH, PDCCH).

PDSCH 1658 is the physical channel that carries the DL-SCH originating from a higher layer, i.e. there is a particular transport channel mapped to PDSCH. For example, DL-SCH 1656 is shown mapped to PDSCH 1658.

PDCCH 1660 is the physical channel that carries control information, e.g. DCI, and PDCCH has no corresponding transport channel. With the provided methods, one-stage DCI 1662 and first stage DCI 1664 are carried by PDCCH 1660, second stage DCI 1666 is carried by PDSCH 1658, but as noted above there is no multiplexing between the DCI and the downlink data on PDSCH 1658. While the PDSCH is generally used to transmit transport blocks including downlink data from a DL-SCH, when a transport block transmitted on the PDSCH is carrying the second stage DCI, the PDSCH does not carry DL-SCH.

According to the third aspect of the present disclosure, two-stage DCI are used for conveying UE-specific and/or cluster-specific control information to participating UEs during a multi-stage AI/ML model training process. For example, in some embodiments the two-stage DCI provided herein may be used for cluster AI/ML sub-model indications, for cluster merging indications and/or for cluster switching indications, as discussed in further detail below.

### Two-Stage DCI for Cluster Sub-Model Indications

For example, referring again to the example of a multi-stage AI/ML training process discussed above with reference to FIGS. 10 to 15, a network device, such as the network device 452 in the foregoing example, may use two-stage DCI for indicating the cluster sub-models to the clusters of devices participating in the training process. For example, for a UE that is assigned to a particular cluster, the network device may assign the UE a cluster ID corresponding to the particular cluster, and assign a specific RNTI to the particular cluster (e.g. a cluster-specific RNTI such as cluster-j-RNTI). The cluster-specific RNTI can be used by the UE to receive the cluster sub-model, as detailed below. In addition, the network device may assign a common RNTI all UEs participating in AI/ML training process (e.g. cluster-common-RNTI for all UEs in different clusters). The function of the common RNTI is for receiving first stage DCI for all devices participating in the AI/ML training process.

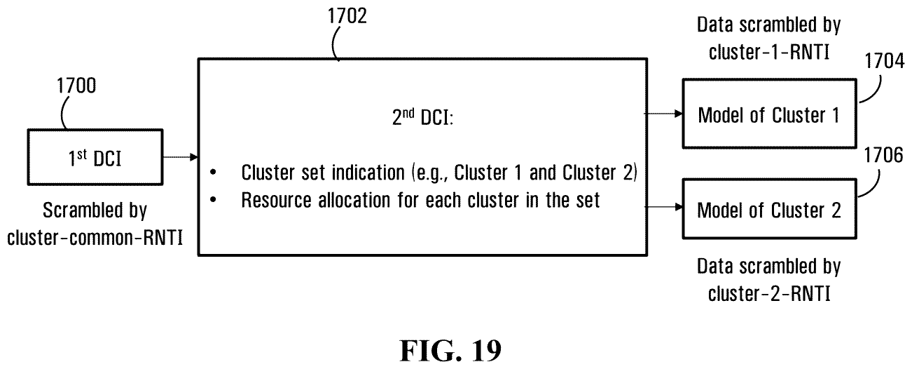

FIG. 19 shows an example of a two-stage DCI in which the second DCI indicates scheduling information for cluster-specific downlink transmissions according to one embodiment. The two-stage DCI shown in FIG. 19 includes a first stage DCI 1700 and a second stage DCI 1702. As shown in FIG. 19, the network device sends the first stage DCI 1700 scrambled by the common RNTI (i.e., cluster-common RNTI, which has been commonly assigned to all devices participating in the AI/ML training process) so that all devices participating in the AI/ML training process can decode the first stage DCI, wherein the scheduling information for the second stage DCI 1702 is scrambled by the cluster-common-RNTI in the first stage DCI 1700.

In this example, the second stage DCI 1702 includes scheduling information indicating which cluster(s) have a scheduled downlink transmission and the corresponding scheduled resources. For example, in some embodiments the second stage DCI 1702 could include a field to indicate which cluster(s) will be scheduled, i.e. indicating that cluster sub-model information is included in the scheduled resources. For example, the second stage DCI 1702 could include a field called “cluster set indication” that indicates the cluster ID(s) which are scheduled. For example, the cluster indication field could include a bitmap to indicate which cluster(s) are scheduled, e.g., if there are N clusters, the network device could use N bits of the bitmap for indicating which cluster(s) are indicated, wherein each bit is associated to one of the N clusters, if the bit value equals 1, the cluster is scheduled and if the bit value equals 0, the cluster is not-scheduled, or vice versa. Alternatively, the second stage DCI 1702 could explicitly indicate the cluster ID(s) which are scheduled. For example, referring again to FIGS. 7A and 7B, the second stage DCI 1702 could explicitly indicate the cluster ID assigned to Cluster 1 and the cluster ID assigned to Cluster 2 in order to indicate that cluster-specific cluster sub-model information for Cluster 1 and Cluster 2 is included in the scheduled resources. In addition, the second stage DCI also includes resource allocation information for each scheduled cluster. A UE checks the second DCI 1702 to determine whether its cluster is scheduled. If its cluster is scheduled, the UE may then decode the data scheduled for its cluster. The network device may scramble the cluster-specific data for a given cluster with the cluster-specific RNTI assigned to that cluster. A UE in that cluster may then decode the data by descrambling with its indicated cluster-specific RNTI (cluster-j-RNTI). For example, as shown in FIG. 19, the data 1704 for the cluster sub-model for Cluster 1 may be scrambled by the cluster-specific RNTI assigned to Cluster 1 (e.g., cluster-1-RNTI) and the data 1706 for the cluster sub-model for Cluster 2 may be scrambled by the cluster-specific RNTI assigned to Cluster 2 (e.g., cluster-2-RNTI). The benefit of scrambling the cluster data with the cluster-specific RNTI is to prevent UEs that do not belong to the cluster from decoding the information.

For example, referring again to FIG. 13, it is noted that the downlink transmissions of the cluster AI/ML sub-model update at 1105₁ and 1105₂ may have been scheduled utilizing two-stage DCI in the manner described above. Furthermore, the cluster AI/ML sub-model update data contained in those transmissions may have been scrambled by the cluster-specific RNTI assigned to the cluster that includes UE 402, i.e., cluster-i-RNTI.

Two-stage DCI may also or instead be used to indicate that two or more clusters are merged into a new cluster and/or that a specific device is switched to a different cluster. For example, a network device may use two-stage DCI to perform a cluster merging or cluster switching operation during cluster sub-model training. For example, if a network device observes two cluster models are getting similar (e.g., if the correlation between two cluster sub-models is equal to or greater than a threshold value), the network device BS could perform merging of the two sub-models and the two corresponding clusters of devices in order to reduce DL overhead. In addition or instead, if a network device observes that the cluster assignment for a UE could be optimized by changing to another cluster, the network device may perform a cluster switching operation to switch/re-assign the UE to the other cluster. For example, a network device may base such a decision on the UE's correlation report and/or a change in the UE's training data and/or a change in the UE's AI/ML training capability.

Examples of cluster merging and cluster switching operations using two-stage DCI are described below.

### Two-stage DCI for Dynamic Cluster Merging Indications

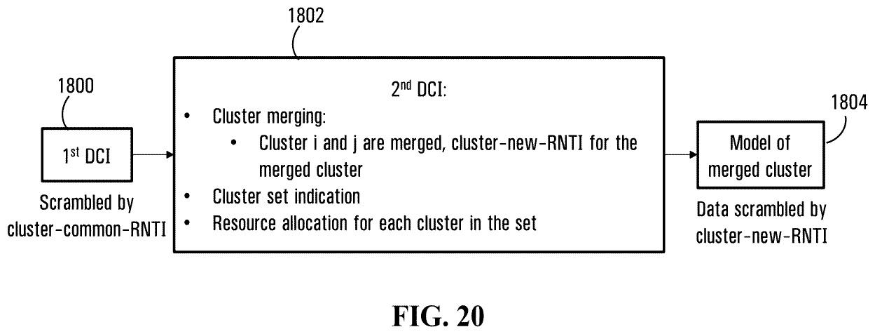

In order to affect a cluster merging operation, a network device could send a two-stage DCI in which the second DCI indicates cluster merging information. An example of such a two-stage DCI is shown in FIG. 20. In this example, the two-stage DCI includes a first stage DCI 1800 and a second stage DCI 1802. The first stage DCI 1800 is scrambled by a common RNTI (i.e., cluster-common-RNTI), and there is a field in the second stage DCI 1802 that indicates the cluster merging information. For example, as shown in FIG. 20, the second stage DCI 1802 could include a “cluster merging” field to indicate the cluster merging information. For example, the cluster merging information could include information indicating, for each new merged cluster, the list of two or more clusters that are being merged into the new merged cluster. For example, referring again to the communication system 700 shown in FIGS. 7A and 7B, for the merging of Cluster 1 and Cluster 2 into a new Cluster 3, the cluster merging field could include an entry indicating (cluster ID 1, cluster ID 2, cluster ID 3). In some implementations, the cluster merging field may optionally include: an entry indicating the total number of new merged cluster N (the value of N could be predefined or RRC configured or indicated by the first stage DCI 1800); and N sets of (cluster ID i, cluster ID j, cluster-new-RNTI for the merged cluster of i and j).

Referring again to FIG. 20, by receiving the second stage DCI 1802, a UE with cluster ID i or j knows it should use cluster-new-RNTI for receiving the cluster sub-model in further learning iteration. Optionally, the network device could also indicate the scheduling information for the merged cluster in the second DCI 1802, and the UE with cluster ID i or j could then use the indicated cluster-new-RNTI for descrambling the data 1804 of the merged cluster sub-model.

### Two-stage DCI for Dynamic UE Cluster Switching Indications

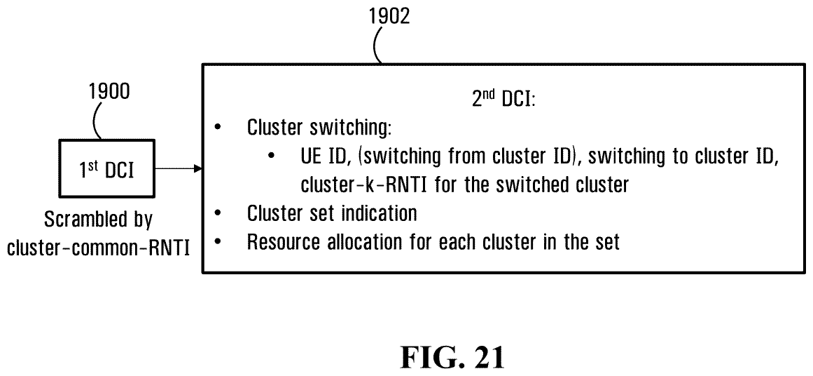

In order to affect a cluster switching operation for a UE, a network device could send a two-stage DCI in which the second DCI indicates cluster switching information. An example of such a two-stage DCI is shown in FIG. 21. In this example, it is assumed that the network device has configured a UE ID to a UE, which allows the network device to identify the UE in the cluster switching signaling. In this example, the two-stage DCI includes a first stage DCI 1900 and a second stage DCI 1902. The first stage DCI 1900 is scrambled by a common RNTI (i.e., cluster-common-RNTI), and there is a field in the second stage DCI 1902 that indicates the cluster switching information. For example, as shown in FIG. 21, the second stage DCI 1902 could include a “cluster switching” field to indicate the cluster switching information. For example, the cluster switching information could include information indicating, for each UE that is being switched, the UE ID assigned to the UE, the cluster ID of the cluster that the UE is being switched to, and the cluster-specific RNTI assigned to that cluster. For example, referring again to the communication system 700 shown in FIGS. 7A and 7B, in order to switch UE 1 from Cluster 1 to Cluster 2, the cluster switching field could include an entry indicating (UE 1 ID, cluster ID 2, cluster-2-RNTI). In some implementations, the cluster switching field information also indicates the cluster ID of the cluster from which the UE is being switched. For example, the entry for switching UE 1 from Cluster 1 to Cluster 2 could further include the cluster ID for Cluster 1 to indicate that UE 1 is currently assigned to Cluster 1 and is being switched to Cluster 2, e.g., the entry could indicate: (UE 1 ID, cluster ID 1, cluster ID 2, cluster-2-RNTI). In some implementations, the cluster switching field may optionally further include: an entry indicating the total number N of cluster switching operations being indicated (the value of N could be predefined or RRC configured or indicated by the first stage DCI 1800); and N sets of (UE ID, switching from cluster ID (optional), switching to cluster ID, cluster-k-RNTI for the switched cluster).

Referring again to FIG. 21, by receiving the second stage DCI 1902 and checking the “cluster switching” field, a UE knows whether the cluster for the UE is switched, and switched to which cluster.

Furthermore, it is noted that, in addition to the two-stage DCI indication for the cluster sub-model indication, cluster merging, cluster switching, a network device could also or instead use RRC, MAC-CE, or other DCIs (for example, one-stage DCI) for one or more of the foregoing operations. For example, in some embodiments, in addition to having a first stage DCI that is used for scheduling second stage DCI, for certain purposes, a network device may also or instead use a one-stage DCI for such operations, which is a standalone DCI that is not used to schedule a second stage DCI. A one stage DCI may be used, for example, for scheduling the downlink transmissions of the cluster AI/ML sub-model update at 1105₁ and 1105₂ in FIG. 13. In which case, the CRC of the one stage DCI is scrambled by the cluster-specific RNTI assigned to the cluster that includes UE 402, i.e., cluster-i-RNTI.

By performing the methods disclosed herein, the air interface resource overhead and delays associated with online AI/ML model training can be reduced while providing a tradeoff between overhead reductions and training performance.

Examples of devices (e.g. ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein, e.g. in relation to FIGS. 11-16. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

What is claimed is:

1. A method, comprising:
receiving, by a first device in a wireless communication network, first artificial intelligence or machine learning (AI/ML) sub-model configuration information from a network device for configuring a first AI/ML sub-model, the first AI/ML sub-model configuration information being received using a first radio network temporary identifier (RNTI);
receiving, by the first device, second AI/ML sub-model configuration information from the network device for configuring a second AI/ML sub-model, the second AI/ML sub-model configuration information being received using a second RNTI different from the first RNTI; and
configuring, by the first device, an AI/ML model on the first device, wherein the AI/ML model comprises the first AI/ML sub-model and the second AI/ML sub-model, the first AI/ML sub-model and the second AI/ML sub-model are cascaded, and wherein an output of the first AI/ML sub-model is an input of the second AI/ML sub-model.

2. The method of claim 1, wherein one of the first AI/ML sub-model and the second AI/ML sub-model is an AI/ML sub-model 1 that is common to a group of devices in the wireless communication network, and the other one of the first AI/ML sub-model and the second AI/ML sub-model is an AI/ML sub-model 2 that is common to a first cluster of one or more devices, inclusive of the first device, within the group of devices.

3. The method of claim 2, further comprising:
receiving signaling from the network device configuring the first device to train the AI/ML model on the first device in accordance with a training stage selected from a plurality of training modes of a multi-stage AI/ML model training process, the plurality of training modes comprising a first training stage in which parameters of the AI/ML sub-model 1 are trained and parameters of the AI/ML sub-model 2 are fixed; and
transmitting local AI/ML model update information to the network device, the local AI/ML model update information being based on training of the AI/ML model on the first device in accordance with the selected training stage.

4. The method of claim 3, wherein the selected training stage is the first training stage.

5. The method of claim 3, wherein the selected training stage is a second training stage of the plurality of training modes, wherein in the second training stage parameters of the AI/ML sub-model 2 are trained.

6. The method of claim 2, further comprising:
receiving, from the network device, global cluster-specific AI/ML sub-model update information comprising global cluster-specific AI/ML sub-model parameter updates for a global cluster-specific AI/ML sub-model; and
updating the configuration of the AI/ML sub-model 2 on the first device based on the global cluster-specific AI/ML sub-model parameter updates received from the network device.

7. A method, comprising:
configuring, by a network device in a wireless communication network, a first global artificial intelligence or machine learning (AI/ML) model, wherein the first global AI/ML model comprises a first global AI/ML sub-model and a second global AI/ML sub-model, the first global AI/ML sub-model and the second global AI/ML sub-model are cascaded, and wherein an output of the first global AI/ML sub-model is an input of the second global AI/ML sub-model; and
wherein one of the first global AI/ML sub-model and the second global AI/ML sub-model is a global common AI/ML sub-model that is common to a group of devices in the wireless communication network, and the other one of the first global AI/ML sub-model and the second global AI/ML sub-model is a first global cluster-specific AI/ML sub-model that is common to a first cluster of one or more devices within the group of devices.

8. The method of claim 7, further comprising:
transmitting, by the network device, first AI/ML model configuration information for configuring, on a first device in the wireless communication network, an AI/ML model corresponding to the first global AI/ML model, wherein the AI/ML model on the first device comprises a first AI/ML sub-model corresponding to the first global AI/ML sub-model and a second AI/ML sub-model corresponding to the second global AI/ML sub-model, the first AI/ML sub-model and the second AI/ML sub-model are cascaded, wherein an output of the first AI/ML sub-model is an input of the second AI/ML sub-model, the first AI/ML model configuration information comprises AI/ML model parameters for the first AI/ML sub-model and the second AI/ML sub-model, and wherein the first device belongs to the first cluster of one or more devices.

9. The method of claim 8, wherein transmitting the first AI/ML model configuration information for configuring the first AI/ML model on the first device comprises:
transmitting, by the network device, first AI/ML sub-model configuration information for configuring the first AI/ML sub-model, the first AI/ML sub-model configuration information being transmitted using a first radio network temporary identifier (RNTI); and
transmitting, by the network device, second AI/ML sub-model configuration information for configuring the second AI/ML sub-model, the second AI/ML sub-model configuration information being transmitted using a second RNTI different from the first RNTI.

10. The method of claim 8, further comprising:
transmitting, by the network device, signaling to configure the first device to train the AI/ML model on the first device in accordance with a training stage selected from a plurality of training modes of a multi-stage AI/ML model training process, the plurality of training modes comprising a first training stage in which parameters of the global common AI/ML sub-model are trained and parameters of the first global cluster-specific AI/ML sub-model are fixed; and
receiving, by the network device, local AI/ML model update information from the first device, the local AI/ML model update information being based on training of the AI/ML model on the first device in accordance with the selected training stage.

11. The method of claim 10, wherein the selected training stage is the first training stage.

12. The method of claim 10, wherein the selected training stage is a second training stage of the plurality of training modes, wherein in the second training stage parameters of the first global cluster-specific AI/ML sub-model are trained.

13. The method of claim 7, further comprising:
transmitting, by the network device, global cluster-specific AI/ML sub-model update information comprising global cluster-specific AI/ML sub-model parameter updates for the global cluster-specific AI/ML sub-model for the first cluster of devices.

14. A device comprising:
at least one processor; and
a memory storing processor-executable instructions that, when executed, cause the at least one processor to:
receive, from a network device in a wireless communication network, first artificial intelligence or machine learning (AI/ML) sub-model configuration information for configuring a first AI/ML sub-model, the first AI/ML sub-model configuration information being received using a first radio network temporary identifier (RNTI);
receive, from the network device, second AI/ML sub-model configuration information for configuring a second AI/ML sub-model, the second AI/ML sub-model configuration information being received using a second RNTI different from the first RNTI; and
configure an AI/ML model on the device, the AI/ML model comprising a first AI/ML sub-model and a second AI/ML sub-model, the first AI/ML sub-model and the second AI/ML sub-model being cascaded, and wherein an output of the first AI/ML sub-model is an input of the second AI/ML sub-model.

15. The device of claim 14, wherein one of the first AI/ML sub-model and the second AI/ML sub-model is an AI/ML sub-model 1 that is common to a group of devices in the wireless communication network, and the other one of the first AI/ML sub-model and the second AI/ML sub-model is an AI/ML sub-model 2 that is common to a first cluster of one or more devices, inclusive of the device, within the group of devices.

16. The device of claim 15, wherein the processor-executable instructions further comprise processor-executable instructions that, when executed, cause the at least one processor to:
receive signaling from the network device configuring the device to train the AI/ML model on the device in accordance with a training stage selected from a plurality of training modes of a multi-stage AI/ML model training process, the plurality of training modes of the multi-stage AI/ML model training process comprising a first training stage in which parameters of the AI/ML sub-model 1 are trained and parameters of the AI/ML sub-model 2 are fixed; and
transmit local AI/ML model update information to the network device, the local AI/ML model update information being based on training of the AI/ML model on the device in accordance with the selected training stage.

17. The device of claim 16, wherein the signaling configures the device to train the AI/ML model on the device in accordance with the first training stage in which parameters of the AI/ML sub-model 1 are trained and parameters of the AI/ML sub-model 2 are fixed.

18. The device of claim 16, wherein the signaling configures the device to train the AI/ML model on the device in accordance with a second training stage of the plurality of training modes, wherein in the second training stage parameters of the AI/ML sub-model 2 are trained.

19. The device of claim 15, wherein the processor-executable instructions further comprise processor-executable instructions that, when executed, cause the at least one processor to:
receive, from the network device, global cluster-specific AI/ML sub-model update information comprising global cluster-specific AI/ML sub-model parameter updates for a global cluster-specific AI/ML sub-model; and
update configuration of the AI/ML sub-model 2 on the device based on the global cluster-specific AI/ML sub-model parameter updates received from the network device.

20. A network device comprising:
at least one processor; and
a memory storing processor-executable instructions that, when executed, cause the at least one processor to:
configure a first global artificial intelligence or machine learning (AI/ML) model, wherein the first global AI/ML model comprises a first global AI/ML sub-model and a second global AI/ML sub-model, the first global AI/ML sub-model and the second global AI/ML sub-model are cascaded, and wherein an output of the first global AI/ML sub-model is an input of the second global AI/ML sub-model; and
wherein one of the first global AI/ML sub-model and the second global AI/ML sub-model is a global common AI/ML sub-model that is common to a group of devices in the wireless communication network, and the other one of the first global AI/ML sub-model and the second global AI/ML sub-model is a first global cluster-specific AI/ML sub-model that is common to a first cluster of one or more devices within the group of devices.

21. The network device of claim 20, wherein the processor-executable instructions further comprise processor-executable instructions that, when executed, cause the at least one processor to:
transmit first AI/ML model configuration information for configuring, on a first device in the wireless communication network, an AI/ML model corresponding to the first global AI/ML model, wherein the AI/ML model on the first device comprises a first AI/ML sub-model corresponding to the first global AI/ML sub-model and a second AI/ML sub-model corresponding to the second global AI/ML sub-model, the first AI/ML sub-model and the second AI/ML sub-model being cascaded, wherein an output of the first AI/ML sub-model is an input of the second AI/ML sub-model, the first AI/ML model configuration information comprising AI/ML model parameters for the first AI/ML sub-model and the second AI/ML sub-model, wherein the first device belongs to the first cluster of one or more devices.

22. The network device of claim 21, wherein transmitting the first AI/ML model configuration information for configuring the first AI/ML model on the first device comprise:
transmitting first AI/ML sub-model configuration information for configuring the first AI/ML sub-model, the first AI/ML sub-model configuration information being transmitted using a first radio network temporary identifier (RNTI); and
transmitting second AI/ML sub-model configuration information for configuring the second AI/ML sub-model, the second AI/ML sub-model configuration information being transmitted using a second RNTI different from the first RNTI.

23. The network device of claim 21, wherein the processor-executable instructions further comprise processor-executable instructions that, when executed, cause the at least one processor to:
transmit signaling to configure the first device to train the AI/ML model on the first device in accordance with a training stage selected from a plurality of training modes of a multi-stage AI/ML model training process, the plurality of training modes of the multi-stage AI/ML model training process comprising a first training stage in which parameters of the global common AI/ML sub-model are trained and parameters of the first global cluster-specific AI/ML sub-model are fixed; and
receive local AI/ML model update information from the first device, the local AI/ML model update information being based on training of the AI/ML model on the first device in accordance with the selected training stage.

24. The network device of claim 23, wherein the signaling configures the first device to train the AI/ML model on the first device in accordance with the first training stage in which parameters of the global common AI/ML sub-model are trained and parameters of the first global cluster-specific AI/ML sub-model are fixed.

25. The network device of claim 23, wherein the signaling configures the first device to train the AI/ML model on the first device in accordance with a second training stage of the plurality of training modes, wherein in the second training stage parameters of the first global cluster-specific AI/ML sub-model are trained.

26. The network device of claim 20, wherein the processor-executable instructions further comprise processor-executable instructions that, when executed, cause the at least one processor to:
transmit global cluster-specific AI/ML sub-model update information comprising global cluster-specific AI/ML sub-model parameter updates for the global cluster-specific AI/ML sub-model for the first cluster of devices.
